(19) United States
(12) Patent Application Publication
(10) Pub. No.: US 2014/0248475 A1
(43) Pub. Date: Sep. 4, 2014

(54) BIOCOMPATIBLE MEMBER AND METHOD FOR FORMING BIOCOMPATIBLE MEMBER

(71) Applicant: FUJIFILM Corporation, Tokyo (JP)

(72) Inventor: Seishi KASAI, Ashigarakami-gun (JP)

(73) Assignee: FUJIFILM CORPORATION, Tokyo (JP)

(21) Appl. No.: 14/224,636

(22) Filed: Mar. 25, 2014

Related U.S. Application Data
(63) Continuation of application No. PCT/JP2012/074314, filed on Sep. 14, 2012.

(30) Foreign Application Priority Data
Sep. 27, 2011 (JP) 2011-211329

(51) Int. Cl. C09D 11/00

(52) U.S. Cl. CPC C09D 11/38
USPC 428/201; 428/195.1; 347/20

(57) ABSTRACT

There is provided a biocompatible member comprising: a base material; and a film provided on the base material, wherein the biocompatible member includes: 1) a compound having a phosphorylcholine group, and 2) a polymer of a polymerizable compound, or an oligomer or polymer compound, provided that 2) the polymer of a polymerizable compound, or the oligomer or polymer compound does not have a phosphorylcholine group, the film is a composition gradient film in which the composition of 1) and 2) continuously varies in such a manner that the proportion of 1) increases and the proportion of 2) decreases from the side closest to the base material to the side farthest from the base material along a film thickness direction.

### CROSS REFERENCE TO RELATED APPLICATION

This is a continuation of International Application No. PCT/JP2012/074314 filed on Sep. 14, 2012, and claims priority from Japanese Patent Application No. 2011-211329 filed on Sep. 27, 2011, the entire disclosures of which are incorporated therein by reference.

### TECHNICAL FIELD

The present invention relates to biocompatible members, and to methods for forming biocompatible members. Specifically, the invention relates to a novel biocompatible member and a method for forming same that provide desirable adhesion between various base materials of the biocompatible member and a film, and that impart high biocompatibility to the film surface while maintaining excellent hydrophilicity and water resistance.

### BACKGROUND ART

Metallic materials currently in use for medical devices (for example, such as (auxiliary) artificial hearts, prosthetic valves, stents, and pacemakers) satisfy essentially all the requirements for mechanical properties, but are insufficient in terms of biocompatibility (including antithrombogenicity). Because of the insufficient biocompatibility of the medical devices, the medical device blocks the blood flow and causes a serious damage to the human body when, for example, the blood components contact the surface of the medical device and form a blood clot. This has created the need for drugs that suppress the protective responses of the body undergoing a treatment with such a medical device in clinical practice. The drugs, however, are very problematic because of their side effects in long-term use. A biocompatible (including antithrombogenicity) material is therefore essential for the development of a medical device that can be used for extended time periods by being embedded in the body.

In dental implants, prosthetic treatments using removable partial dentures and bridges have been practiced for dental losses caused by periodontal disease or dental caries. However, removable partial dentures are aesthetically problematic, because the treatment involves the use of a clasp or other devices. Discomfort from installation is also a problem. The problem of the bridge is that it unavoidably involves the demanding grinding of an abutment tooth. Dental implant treatments have attracted interest in recent years as alternative to other prosthetic therapies, and have been practiced in increasing numbers. However, dental implant treatments necessarily involve penetration of the foreign object implant into the epithelium. It has therefore been an important challenge to suppress plaque deposition in areas of the gum penetrated by the implant, and to prevent inflammation around the implant for the maintenance of the dental implant functionality over extended time periods.

These problems are addressed in methods that propose controlling the surface properties of the medical device or dental materials themselves to provide antithrombogenicity or anti-cell adhesion properties. WO 2009/081870 discloses a biocompatible member that includes an adhesive layer formed on a metallic base, and a biocompatible material layer of MPC polymer formed by graft polymerization of 2-methacryloyloxyethyl phosphorylcholine (MPC) which is the anti-blood clotting, anti-cell adherent material on the adhesive layer. JP-T-2007-530733 (the term “JP-T” as used herein means a published Japanese translation of a PCT patent application) discloses a stent coating structure in which a primer layer having polybutylmethacrylate, a reservoir layer, and a topcoat layer having a polymer of an MPC structure are formed on a stent. This publication describes the possibility of laminating the coating structure by spray coating with increasing concentration gradients of the phospholipid component toward the outermost layer.

In the biocompatible member described in WO 2009/081870, the MPC in the biocompatible layer exists as a graft chain, and the excluded volume effect of the graft chain makes it difficult to increase the segment density. As a result, sufficient anti-blood clotting and anti-cell adhesion properties cannot be developed. When the thickness of the MPC graft layer is increased to obtain sufficient anti-blood clotting and anti-cell adhesion properties, the graft layer MPC polymer chemically not attached to the adhesive layer dissolves into the liquid in contact with the polymer, and the durability deteriorates as a result. Further, sufficient polymerization reaction does not occur on complex curved surfaces or the like, and the graft layer cannot be formed as intended. Further, because the adhesive layer is additionally coated and is not essential for the development of the intended functions, the adhesive layer adds to the steps and costs.

In the coating structure described in JP-T-2007-530733, the concentration gradient of the phospholipid component in the coating structure is stepwise, and a cohesive failure tends to occur in the layer, with the result that the adhesion suffers. Further, it is difficult with the spray coating described in JP-T-2007-530733 to form a film having the continuous composition gradient described in the present invention. Further, direct patterning on the base material is not possible with the spray coating, and the technique cannot meet the demand for partially imparting anti-blood clotting and anti-cell adhesion properties to the base material.

### SUMMARY OF INVENTION

There is difficulty in imparting adhesion between a base material and a biocompatible (anti-blood clotting, anti-cell adsorption) material (hydrophilic) of inherently different properties and poor compatibility. The techniques of the related art try to impart adhesion with an adhesive layer formed of a material that has the properties of both the base material and the biocompatible material (for example, a hybrid material of a silica sol gel and an organic polymer), and that has certain adhesion for the both materials. However, in principle, detachment occurs at the interfaces with the different materials, and it cannot be said that sufficient adhesion is imparted. Further, imparting adhesion by chemically bonding the biocompatible (anti-blood clotting and anti-cell adsorption) material to the base material surface through graft polymerization as disclosed in WO 2009/081870 is problematic, because the surface graft method involves low segment density, and cannot develop the intended biocompatibility (anti-blood clotting and anti-cell adsorption properties). The method is therefore not suited for production in actual practice. The present invention takes a completely different approach, and forms a gradient composition structure in which a biocompatible (anti-blood clotting and anti-cell adsorption) material (hydrophilic) and a material highly adherent to the base material are provided in varying proportions from the side closest to the base material to the side the farthest from the base material. Accordingly, there is no distinct interface between the different materials, and both biocompatibility (farthest from the base material) and base material adhesion (closest to the base material) can be realized at a high level.

The present invention has been made under these circumstances, and provides a novel biocompatible member and a method for forming same that provide desirable adhesion between various base materials of the biocompatible member and a film, and that impart high biocompatibility to the film surface while maintaining excellent hydrophilicity and water resistance.

The present invention is as follows.

<1> A biocompatible member comprising:

a base material; and

a film provided on the base material,

wherein the biocompatible member includes:
1) a compound having a phosphorylcholine group, and
2) a polymer of a polymerizable compound, or an oligomer or polymer compound, provided that 2) the polymer of a polymerizable compound, or the oligomer or polymer compound does not have a phosphorylcholine group,

the film is a composition gradient film in which the composition of 1) and 2) continuously varies in such a manner that the proportion of 1) increases and the proportion of 2) decreases from the side closest to the base material to the side farthest from the base material along a film thickness direction.

<2> The biocompatible member as described in <1> above,

wherein the composition gradient film has a thickness of 1 μm or more, and

wherein the proportion of the mass of 1) the compound having a phosphorylcholine group with respect to the total mass of 1) the compound having a phosphorylcholine group, and 2) the polymer of a polymerizable compound, or the oligomer or polymer compound in the composition gradient film has a 1% to 50% difference between any adjacent measurement points taken at 0.1-μm intervals from the side closest to the base material along the film thickness direction.

<3> The biocompatible member as described in <1> or <2> above,

wherein the polymerizable compound, or the oligomer or polymer compound has two or more polymerizable functional groups per molecule.

<4> The biocompatible member as described in any one of <1> to <3> above,

wherein 1) the compound having a phosphorylcholine group is 2-methacryloyloxyethyl phosphorylcholine, or a polymer thereof.

<5> The biocompatible member as described in any one of <1> to <4> above,

wherein the component 2) is a polymer of a polymerizable compound, and the polymerizable compound contains at least one selected from the group consisting of an N-vinyl compounds and a (meth)acrylate compound.

<6> The biocompatible member as described in <5> above, wherein the polymerizable compound contains N-vinyl caprolactam as the N-vinyl compound.
<7> The biocompatible member as described in <6> above, wherein the content of the N-vinyl caprolactam in the polymerizable compound is 40 mass % or more.
<8> The biocompatible member as described in any one of <1> to <7> above,

wherein the component 2) is a polymer of a polymerizable compound, and is formed by polymerizing and curing the polymerizable compound with an active energy ray.

<9> The biocompatible member as described in any one of <1> to <4> above,

wherein the component 2) is an oligomer or polymer compound, and the oligomer or polymer compound contains a urethane bond.

<10> A method for forming the biocompatible member of any one of <1> to <9> above, comprising:

ejecting on the base material at least two ink compositions including an ink composition containing the compound having a phosphorylcholine group, and an ink composition containing the polymerizable compound or the oligomer or polymer compound by using an inkjet method.

<11> The method as described in <10> above.

wherein the inkjet method uses at least a first inkjet head and a second inkjet head, and the method comprises:

a step of supplying the ink composition containing the compound having a phosphorylcholine group to the first inkjet head as a first ink;

a step of supplying the ink composition containing the polymerizable compound or the oligomer or polymer compound to the second inkjet head as a second ink;

a control step of deciding the proportion of the amount of the first ink ejected from the first inkjet head and the proportion of the amount of the second ink ejected from the second inkjet head;

a forming step of forming a single layer by ejecting the first ink or the second ink from at least one of the first inkjet head and the second inkjet head according to the decided proportions; and

a laminate step of repeating the forming step to laminate a plurality of layers on the base material and obtain the composition gradient film,

wherein in the control step the proportions are decided in such a manner that the proportion of the first ink increases and the proportion of the second ink decreases from the side closest to the base material to the side farthest from the base material along the thickness of the plurality of layers.

<12> The method as described in <11> above,

wherein the amount of ink droplets ejected from the first inkjet head and the second inkjet head in the forming step is 0.3 to 100 pL.

<13> The method as described in <11> or <12> above, wherein the size of ink droplets ejected from the first inkjet head and the second inkjet head in the forming step is 1 to 300 μm.
<14> The method as described in <10> above,

wherein the inkjet method uses a plurality of inkjet heads, and the method comprises:

a step of supplying mixed inks to the respective inkjet heads of the plurality of inkjet heads in which the mixed inks are the mixed inks of the first ink which is an ink composition containing the compound having a phosphorylcholine group and the second ink which is an ink composition containing the polymerizable compound or the oligomer or polymer compound, and the mixed inks are different from one another in mixed proportion of the first ink and the second ink;

a selecting step of sequentially selecting an inkjet head from the plurality of inkjet heads in order of decreasing proportions of the second ink in the mixed inks;

a forming step of forming a single layer by ejecting the mixed ink from the selected inkjet head; and

a laminate step of repeating the forming step to laminate a plurality of layers on the base material and obtain the composition gradient film.

<15> The method as described in <14> above,

wherein the amount of ink droplets ejected from the selected inkjet head in the forming step is 0.5 to 150 pL.

<16> The method as described in <14> or <15> above.

wherein the size of ink droplets ejected from the selected inkjet head in the forming step is 2 to 450 μm.

<17> The biocompatible member as described in any one of <1> to <9> above.

wherein the biocompatible member is formed by ejecting on the base material at least two ink compositions including an ink composition containing the compound having a phosphorylcholine group, and an ink composition containing the polymerizable compound or the oligomer or polymer compound by using an inkjet method,

wherein the inkjet method uses at least a first inkjet head and a second inkjet head, and the method includes:

a step of supplying the ink composition containing the compound having a phosphorylcholine group to the first inkjet head as a first ink;

a step of supplying the ink composition containing the polymerizable compound or the oligomer or polymer compound to the second inkjet head as a second ink;

a control step of deciding the proportion of the amount of the first ink ejected from the first inkjet head and the proportion of the amount of the second ink ejected from the second inkjet head;

a forming step of forming a single layer by ejecting the first ink or the second ink from at least one of the first inkjet head and the second inkjet head according to the decided proportions; and

a laminate step of repeating the forming step to laminate a plurality of layers on the base material and obtain the composition gradient film,

wherein in the control step the proportions are decided in such a manner that the proportion of the first ink increases and the proportion of the second ink decreases from the side closest to the base material to the side farthest from the base material along the thickness of the plurality of layers.

<18> The biocompatible member as described in any one of <1> to <9> above,

wherein the biocompatible member is formed by ejecting on the base material at least two ink compositions including an ink composition containing the compound having a phosphorylcholine group, and an ink composition containing the polymerizable compound or the oligomer or polymer compound by using an inkjet method,

wherein the inkjet method uses a plurality of inkjet heads, and the method includes:

a step of supplying mixed inks to the respective inkjet heads of the plurality of inkjet heads in which the mixed inks are the mixed inks of the first ink which is an ink composition containing the compound having a phosphorylcholine group and the second ink which is an ink composition containing the polymerizable compound or the oligomer or polymer compound, and the mixed inks are different from one another in mixed proportion of the first ink and the second ink;

a selecting step of sequentially selecting an inkjet head from the plurality of inkjet heads in order of decreasing proportions of the second ink in the mixed inks;

a forming step of forming a single layer by ejecting the mixed ink from the selected inkjet head; and

a laminate step of repeating the forming step to laminate a plurality of layers on the base material and obtain the composition gradient film.

The present invention provides a biocompatible member and a method for forming same that provide desirable adhesion between various base materials of the biocompatible member and a film, and that impart high biocompatibility to the film surface while maintaining excellent hydrophilicity and water resistance.

### BRIEF DESCRIPTION OF THE DRAWINGS

FIG. 1 is a schematic view of a biocompatible member that includes a composition gradient film.

FIG. 2 is a schematic view of a biocompatible member that includes a composition gradient film.

FIG. 3 is an overall block diagram of a composition gradient film producing apparatus.

FIG. 4 is a schematic diagram of a drawing unit of the composition gradient film.

FIGS. 5A to 5E are diagrams explaining how the composition gradient film is formed by using a mixed drawing method.

FIGS. 6A to 6C are diagrams explaining another embodiment of the mixed drawing method.

FIG. 7 is an overall block diagram of a composition gradient film producing apparatus according to an embodiment of a mixed ink method.

FIGS. 8A to 8C are diagrams explaining how the composition gradient film is formed by using the mixed ink method.

FIGS. 9A to 9D are diagrams explaining the landing positions of inks in the mixed drawing method.

### DESCRIPTION OF EMBODIMENTS

The present invention is concerned with a biocompatible member that includes:

a base material; and

a film provided on the base material and that includes 1) a compound having a phosphorylcholine group, and 2) a polymer of a polymerizable compound, or an oligomer or polymer compound, wherein the polymer of a polymerizable compound, or the oligomer or polymer compound does not have a phosphorylcholine group,

the film being a composition gradient film in which the composition of 1) and 2) continuously varies in such a manner that the proportion of 1) increases and the proportion of 2) decreases from the side closest to the base material to the side farthest from the base material along a film thickness direction.

The materials used in the present invention are described below. The “composition containing a compound having a phosphorylcholine group”, and the “composition containing a polymerizable compound or an oligomer or polymer compound” described below are preferably used as ink compositions.

### (Compound Having Phosphorylcholine Group)

The biocompatible member of the present invention contains a compound having a phosphorylcholine group which is a biocompatible material (specifically, anti-blood clotting and anti-cell adhesion material).

The compound having a phosphorylcholine group is preferably a compound having a polymerizable functional group. In this way, the compound having a phosphorylcholine group can form an interpenetrating network structure (IPN structure; described later) upon crosslinking to 2) the polymerizable compound or the oligomer or polymer compound via the polymerizable functional group, and can thus maintain high water resistance as one of the surface properties.

Examples of the polymerizable functional group include a (meth)acryloyl group, a styryl group, a (meth)acryloylamide group, and a vinyl ether group, of which an (meth)acryloyl group and a styryl group are preferable, and a (meth)acryloyl group is particularly preferable from the standpoint of copolymerization. Note that the (meth)acryloyl group encompasses both methacryloyl group and acryloyl group.

Examples of the compound (monomer) having a phosphorylcholine group and a polymerizable functional group (hereinafter also referred to as the phosphorylcholine group-containing compound having a polymerizable functional group) include 2-methacryloyloxyethyl phosphorylcholine (MPC), 2-acryloyloxyethyl phosphorylcholine, 4-methacryloyloxybutyl phosphorylcholine, 6-methacryloyloxyhexyl phosphorylcholine ω-methacryloyloxyethylene phosphorylcholine, and 4-styryloxybutyl phosphorylcholine, of which MPC is preferable from the standpoint of copolymerization property and liquid property.

The compound having a phosphorylcholine group may be a polymer of the phosphorylcholine group-containing compound (monomer) having a polymerizable functional group. In this case, the polymer may be a polymer of the compound alone, or a copolymer of two or more of the compound. Further, the polymer may be a copolymer of the phosphorylcholine group-containing compound having a polymerizable functional group, and other polymerizable compounds.

Such other polymerizable compounds are not particularly limited, and compounds used as 2) the polymerizable compound (described later) can be used.

The polymerizable compounds contain preferably two or more polymerizable functional groups, more preferably two to six polymerizable functional groups per molecule. In this way, a stronger crosslinked film, and the IPN structure can be formed.

When the compound having a phosphorylcholine group is a polymer in the present invention, the polymer is preferably one obtained by polymerizing MPC at least used as a polymerizable monomer (hereinafter, “MPC polymer”). In this way, excellent antithrombogenicity, and excellent anti-cell and anti-protein adsorption properties can be obtained.

The polymer can be obtained by using known polymerization methods.

The polymer has a weight average molecular weight of preferably 5,000 to 200,000.

### [Composition Containing Compound Having Phosphorylcholine Group]

The composition containing a compound having a phosphorylcholine group is the composition containing a compound having a phosphorylcholine group described above. The compound may be a monomer or a polymer.

The content of the compound having a phosphorylcholine group in the composition is preferably from 40 mass % to 100 mass % with respect to the total mass in the composition when the compound having a phosphorylcholine group is a monomer, and is preferably 5 mass % to 50 mass % with respect to the total mass in the composition when the compound having a phosphorylcholine group is a polymer (In this specification, mass ratio is equal to weight ratio). Sufficient antithrombogenicity and anti-cell and anti-protein adsorption properties can be developed in these content ranges.

The components described below may be further contained when the composition containing a compound having a phosphorylcholine group is used as an ink in the present invention.

### (Polymerizable Compound)

The composition containing a compound having a phosphorylcholine group according to the present invention may further contain a polymerizable compound. The polymerizable compound is not particularly limited, and compounds used as 2) the polymerizable compound may be used, as will be described later.

The polymerizable compound has preferably two or more polymerizable functional group, more preferably two to six polymerizable functional groups per molecule. In this way, a strong crosslinked film, and the IPN structure (described later) can be formed. The same polymerizable functional groups described above may be used.

The composition containing a compound having a phosphorylcholine group according to the present invention may further contain or may not contain a polymerizable compound. When contained, the content of the polymerizable compound in the composition is preferably 1 mass % to 60 mass %, more preferably 1 mass % to 40 mass %.

### (Radical Polymerization Initiator)

The composition containing a compound having a phosphorylcholine group according to the present invention preferably contains a radical polymerization initiator for the purpose of polymerizing the phosphorylcholine group-containing compound having a polymerizable functional group, or forming a crosslinked structure between the phosphorylcholine group-containing compound having a polymerizable functional group and 2) the polymerizable compound or the oligomer or polymer compound. Examples of the radical polymerization initiator include acetophenones, benzoins, benzophenones, phosphine oxides, ketals, anthraquinones, thioxanthones, azo compounds, peroxides, 2,3-dialkyldione compounds, disulfide compounds, fluoroamine compounds, aromatic sulfonium, lophine dimers, onium salts, borate salts, active esters, active halogens, inorganic complexes, and coumalins. The radical polymerization initiator is also described in JP-A-2008-134585, paragraphs [0141] to [0159], and these may be preferably used also in the present invention.

Many examples can be found in The Latest UV Curing Techniques, Technical Information Institute Co., Ltd. (1991), p. 159, and in Ultraviolet Curing System, Kiyomi Kato (Pub. Sougou Gijyutsu Center, 1989), pp. 65 to 148, and these are also useful in the present invention.

Examples of the commercially available photofragmentation photoradical polymerization initiators preferred for use in the present invention include Irgacure 651, Irgacure 184, Irgacure 819, Irgacure 907, Irgacure 1870 (CGI-403/Irg184=7/3 mixed initiator), Irgacure 500, Irgacure 369, Irgacure 1173, Irgacure 2959, Irgacure 4265, Irgacure 4263, Irgacure 127, and OXE01 (all available from BASF); Kayacure DETX-S, Kayacure BP-100, Kayacure BDMK. Kayacure CTX, Kayacure BMS, Kayacure 2-EAQ, Kayacure ABQ, Kayacure CPTX, Kayacure EPD, Kayacure ITX, Kayacure QTX, Kayacure BTC, and Kayacure MCA (all available from Nippon Kayaku Co., Ltd.); Esacure (KIP100F KB1, EB3, BP, X33, KTO46, KT37, KIP150, TZT; all available from Sartomer); Lucirin TPO (BASF), and combinations thereof.

The radical polymerization initiator is used in preferably 0.1 to 15 mass parts, more preferably 1 to 10 mass parts, with respect to 100 mass parts of the curable compound.

A photosensitizer may be used in addition to the photopolymerization initiator. Specific examples of the photosensitizer include n-butylamine, triethylamine, tri-n-butylphosphine, Michler's ketone, and thioxanthone. Further, auxiliary agents such as azide compounds, thiourea compounds, and mercapto compounds also may be used, either alone or in combination.

Examples of commercially available photosensitizers include Kayacure (DMBI, EPA; Nippon Kayaku Co., Ltd.), and Lucirin TPO (BASF).

### (Solvent)

In the present invention, a solvent may be used for the composition containing a compound having a phosphorylcholine group to provide a preferred form for the production of the composition gradient film.

The solvent may be appropriately selected from water and organic solvents, and is preferably a liquid having a boiling point of 50° C. or more, more preferably an organic solvent having a boiling point of 60° C. to 300° C.

Preferably, the solvent is used in such a proportion that the solid content in the composition containing a compound having a phosphorylcholine group ranges from 1 to 50 mass %, more preferably 5 to 40 mass %. In these ranges, the product ink can have a viscosity that provides desirable workability.

Examples of the solvent include alcohols, ketones, esters, nitriles, amides, ethers, etheresters, hydrocarbons, and halogenated hydrocarbons. Specific examples include alcohols (for example, methanol, ethanol, propanol, butanol, benzyl alcohol, ethylene glycol, propylene glycol, ethylene glycol monoacetate, and cresol), ketones (for example, methyl ethyl ketone, methyl isobutyl ketone, cyclohexanone, and methylcyclohexanone), esters (for example, methyl acetate, ethyl acetate, propyl acetate, butyl acetate, ethyl formate, propyl formate, butyl formate, and ethyl lactate), aliphatic hydrocarbons (for example, hexane, and cyclohexane), halogenated hydrocarbons (for example, methylene chloride, and methylchloroform), aromatic hydrocarbons (for example, toluene, and xylene), amides (for example, dimethylformamide, dimethylacetoamide, and n-methylpyrrolidone), ethers (for example, dioxane, tetrahydrofuran, ethylene glycol dimethyl ether, and propylene glycol dimethyl ether), ether alcohols (for example, 1-methoxy-2-propanol, ethyl cellosolve, and methyl carbinol), and fluoroalcohols (for example, the compounds listed in JP-A-8-143709, paragraph [0020], and in JP-A-1-60807, paragraph [0037]).

These solvents may be used either individually or as a mixture of two or more. Examples of the preferred solvents include toluene, xylene, methyl ethyl ketone, methyl isobutyl ketone, cyclohexanone, methanol, isopropanol, and butanol.

### (Additives)

The composition containing a compound having a phosphorylcholine group used in the present invention may contain additives such as complexing agents, dispersants, surface tension adjusters, anti-fouling agents, water resistance imparting agents, and chemical resistance imparting agents.

Examples of the complexing agents include carboxylic acids such as acetic acid and citric acid, diketones such as acetylacetone, and amines such as triethanolamine. Examples of the dispersants include amines such as stearylamine, and laurylamine.

### [Composition Containing Polymerizable Compound or Oligomer or Polymer Compound]

The composition containing a polymerizable compound or an oligomer or polymer compound is the composition containing a polymerizable compound or an oligomer or polymer compound described below.

### (Polymer of Polymerizable Compound, and Oligomer or Polymer Compound)

The biocompatible member of the present invention contains a polymer of a polymerizable compound, or an oligomer or polymer compound as a resin material that provides adhesion to the base material. It should be noted that the polymerizable compound, the polymer of a polymerizable compound, or the oligomer or polymer compound does not have a phosphorylcholine group.

The polymer of a polymerizable compound is a polymer formed by polymerizing and curing the polymerizable compound with active energy rays.

Preferably, the polymerizable compound, and the oligomer or polymer compound are a compound having a polymerizable functional group. More preferably, the polymerizable compound, or the oligomer or polymer compound has two or more polymerizable functional groups per molecule. When the compound is crosslinked to the phosphorylcholine group-containing compound having a polymerizable functional group via the polymerizable functional group, an IPN structure (described below) can be formed, and even higher water resistance can be maintained. The same polymerizable functional groups described in conjunction with 1) the compound having a phosphorylcholine group may be used.

### (Polymerizable Compound)

The polymerizable compound that can be used in the present invention is a compound that can be cured with active energy rays, and that forms a resin upon being cured. Specifically, 2) the polymer of a polymerizable compound is a polymer formed by polymerizing and curing the polymerizable compound with active energy rays.

As used herein, “active energy rays” are not particularly limited, as long as the irradiation thereof can impart energy that can generate initiation species, and encompass a wide range of rays, including α rays, γ rays, X rays, ultraviolet rays, visible rays, and electron rays. Of these, ultraviolet rays and electron rays are preferred, and ultraviolet rays are particularly preferred from the standpoint of curing sensitivity and device availability. Thus, the ink composition containing the polymerizable compound (curable compound) used in the present invention is preferably an ink composition that can polymerize (cure) upon being irradiated with ultraviolet rays used as active energy rays.

The polymerizable compound is not particularly limited, as long as it can polymerize and cure by being irradiated with active energy rays, and any of radically polymerizable compounds and cationic polymerizable compounds may be used. From the standpoint of stability and compound variation, radically polymerizable compounds are preferred, and compounds having an unsaturated double bond are more preferred.

Any compounds having an unsaturated double bond may be used, as long as the compounds have at least one radically polymerizable ethylenic unsaturated bond within the molecule. The compounds having an unsaturated double bond thus may have any chemical form, such as monomer, oligomer, and polymer. The radically polymerizable compounds may be used either alone, or in a combination of two or more in any proportions to improve the intended properties. Preferably, the radically polymerizable compounds are used in a combination of two or more from the standpoint of controlling performance such as reactivity and physical properties.

In the present invention, the polymerizable compound is not particularly limited, and may be, for example, an N-vinyl compound, a (meth)acrylate compound, an acrylamide compound, a styrene compound, or a vinyl ether compound. Preferably, the polymerizable compound contains at least one selected from N-vinyl compounds and (meth)acrylate compounds, more preferably an N-vinyl compound from the standpoint of improving adhesion by the interaction with the base material, improving compatibility with the phosphorylcholine group-containing polymers (for example, MPC polymers) by hydrogen bonding interaction, and suppressing defects such as a cohesive failure inside the material due to intermolecular cohesive force. Note that the (meth)acrylate compounds encompass both methacrylate compounds and acrylate compounds.

In the present invention, N-vinyl lactams (preferably, N-vinyl caprolactam) are used as N-vinyl compounds, because N-vinyl lactams provide desirable adhesion because of their coordinate interaction with the base material, and can thus improve the cohesive force in the film, and form a strong film.

The compound of the following formula (I) represents a preferred example of N-vinyl lactams.

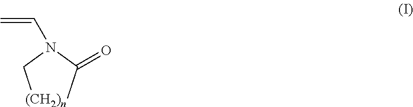

In the formula (I), n represents an integer of 1 to 5, and is preferably an integer of 2 to 4, more preferably an integer of 2 or 4, particularly preferably 4 (specifically, N-vinyl caprolactam) from the standpoint of the flexibility of the cured ink, adhesion to the base material, and the availability of the raw material. N-vinyl caprolactam is preferred, because it is very safe, commonly available at relatively low cost, and can provide desirable ink curability, and desirable adhesion between the cured film and the base material.

The N-vinyl lactams may have a substituent such as an alkyl group, an aryl group on the lactam ring, and may be connected to a saturated or unsaturated ring structure.

Examples of the (meth)acrylate compounds include monofunctional acrylates, multifunctional acrylates, and methacrylates.

Examples of the monofunctional acrylates include 2-hydroxyethyl acrylate, butoxyethyl acrylate, carbitol acrylate, tetrahydrofurfuryl acrylate, bis(4-acryloxypolyethoxyphenyl)propane, epoxy acrylate, and phenoxyethyl acrylate.

Examples of the multifunctional acrylates include neopentylglycol diacrylate, ethylene glycol diacrylate, diethylene glycol diacrylate, triethylene glycol diacrylate, tetraethylene glycol diacrylate, polyethylene glycol diacrylate, dipropylene glycol diacrylate, polypropylene glycol diacrylate, pentaerythritol triacrylate, pentaerythritol tetraacrylate, dipentaerythritol tetraacrylate, trimethylolpropane triacrylate, tetramethylolmethane tetraacrylate, and oligoester acrylate.

Examples of the methacrylates include methyl methacrylate, n-butyl methacrylate, allyl methacrylate, glycidyl methacrylate, dimethylaminomethyl methacrylate, ethylene glycol dimethacrylate, diethylene glycol dimethacrylate, triethylene glycol dimethacrylate, polyethylene glycol dimethacrylate, polypropylene glycol dimethacrylate, trimethylolethane trimethacrylate, trimethylolpropane trimethacrylate, and 2,2-bis(4-methacryloxypolyethoxyphenyl)propane.

Examples of other polymerizable compounds include various radically polymerizable compounds, including unsaturated carboxylic acids such as acrylic acid, methacrylic acid, itaconic acid, crotonic acid, isocrotonic acid, and maleic acid, and salts thereof; anhydrides having an ethylenic unsaturated bond, acrylonitriles, and styrenes; and unsaturated polyesters, unsaturated polyethers, unsaturated polyamides, and unsaturated urethanes.

Specific examples include acrylamides such as N-methylolacrylamide, and diacetoneacrylamide; derivatives of allyl compounds, such as allyl glycidyl ether, diallyl phthalate, and triallyl trimellitate; divinyl benzene; and acryloylmorpholine. More specifically, it is also possible to use commercially available products, and radically polymerizable and crosslinkable monomers, oligomers, and polymers known in the art, including those described in Crosslinking agent Handbook, Shinzo Yamashita (1981, Taiseisha); UV-EB Curing Handbook (Genryo Hen), Kiyomi Kato (1985, Koubunnshi Kankoukai); and Application and Market of UV-EB Cure Technology, RadTech Japan, p. 79 (1989, CMC); and Polyester Resin Handbook, Eiichiro Takiyama (1988, Nikkan Kogyo Shimbun, Ltd.)

From the standpoint of adhesion, it is preferable in the present invention that the polymerizable compound be a combination of N-vinyl caprolactam and other polymerizable compounds other than N-vinyl caprolactam. In this case, the content of the N-vinyl caprolactam in the polymerizable compound is preferably 40 mass % or more of the total mass of the polymerizable compound. Further preferably, the proportions (mass ratio) of the N-vinyl caprolactam and the other compounds are 40:60 to 60:40, more preferably 55:45 to 45:55.

Known examples of the radically polymerizable compounds include the light-curable polymerizable compound materials used for photopolymerizable compositions described in JP-A-7-159983, JP-B-7-31399, JP-A-8-224982, JP-A-10-863, and JP-A-9-134011. These can also be used as the polymerizable compounds in the present invention.

It is also preferable to use vinyl ether compounds as the radically polymerizable compounds. Examples of the vinyl ether compounds preferred for use in the present invention include divinyl or trivinyl ether compounds such as ethylene glycol divinyl ether, ethylene glycol monovinyl ether, diethylene glycol divinyl ether, triethylene glycol monovinyl ether, triethylene glycol divinyl ether, propylene glycol divinyl ether, dipropylene glycol divinyl ether, butanediol divinyl ether, hydroxyethyl monovinyl ether, and trimethylolpropane trivinyl ether, and monovinyl ether compounds such as ethyl vinyl ether, n-butyl vinyl ether, isobutyl vinyl ether, hydroxybutyl vinyl ether, n-propyl vinyl ether, isopropyl vinyl ether, isopropenyl ether-O-propylene carbonate, and diethylene glycol monovinyl ether.

Of these vinyl ether compounds, from the standpoint of curability, adhesion, and surface hardness, the divinyl ether compounds and trivinyl ether compounds are preferred, and divinyl ether compounds are particularly preferred. The vinyl ether compounds may be used either alone or in an appropriate combination of two or more.

It is also preferable to use multifunctional acrylate monomers or multifunctional acrylate oligomers of the foregoing compounds from the standpoint of improving adhesion to the base material, improving film strength, and forming the IPN structure with the compound having a phosphorylcholine group.

As used herein, “a monofunctional compound” is a compound having a single polymerizable group, and “a multifunctional compound” is a compound having two or more polymerizable groups.

### (Radical Polymerization Initiator)

In the composition according to the present invention, a radical polymerization initiator is preferably contained in addition to the polymerizable compound. The same radical polymerization initiators described in conjunction with the composition containing a compound having a phosphorylcholine group may be used.

The cationic polymerizable compound that can be used in the present invention is not particularly limited, as long as it is a compound that undergoes a polymerization reaction and cures by an acid generated from a photo-acid-generating agent. Various known photo-cationic polymerizable monomers may be used. Examples of the cationic polymerizable monomers include the epoxy compounds, vinyl ether compounds, and oxetane compounds described in JP-A-6-9714, JP-A-2001-31892, JP-A-2001-40068, JP-A-2001-55507, JP-A-2001-310938, JP-A-2001-310937, and JP-A-2001-220526.

Polymerizable compounds applicable to cationic polymerizable light-curable resins represent another known example of the cationic polymerizable compounds. As a recent example, JP-A-6-43633 and JP-A-8-324137 describe polymerizable compounds applicable to photo-cationic polymerizable light-curable resins sensitized in a visible wavelength region of 400 nm or more. These can also be used as the polymerizable compounds in the present invention.

Examples of the cationic polymerization initiator (photo-acid-generating agent) used with the cationic polymerizable compound in the present invention include compounds used for chemically amplified photoresists and photo-cationic polymerization (see Organic Materials for Imaging, The Japanese Research Association for Organic Electronics Materials, Bunshin Shuppan (1993), pp. 187 to 192).

Examples of cationic polymerization initiators preferred for use in the present invention are as follows.

The first examples are B(C₆F₅)₄⁻, PF₆⁻, AsF₆⁻, SbF₆⁻, CF₃SO₃⁻ salts of aromatic onium compounds such as diazonium, ammonium, iodonium, sulfonium, and phosphonium. The second examples are sulfonated materials that generate sulfonic acid. The third examples are halides that produce halogenated hydrogen by photogeneration. The fourth examples are iron allene complexes.

These cationic polymerization initiators may be used either alone or in a combination of two or more.

### (Oligomer and Polymer Compounds)

The oligomer or polymer compound that can be used in the present invention is not particularly limited, and, for example, oligomers and polymers such as urethane, alkylmethacrylate, and alkylacrylate, and mixtures thereof may be used.

The oligomer as used herein means, but is not limited to a polymer having a molecular weight of, for example, 1,000 or more and less than 5,000. The polymer means a polymer having a molecular weight of, for example, 5,000 or more, preferably a compound having a molecular weight of 5,000 to 10,000.

The oligomer or polymer compound preferably contains a urethane bond. Specifically, the oligomer or polymer compound is preferably an oligomer containing a urethane bond (hereinafter, “urethane oligomer”) or a polymer containing a urethane bond (hereinafter, “urethane polymer” or “polyurethane”), more preferably a urethane oligomer.

Use of urethane polymers or oligomers is preferred, presumably because the urethane polymers or oligomers provide desirable adhesion because of their coordinate interaction with the base material, and can thus improve the cohesive force in the gradient film, and form a strong film.

The content of the urethane polymer or oligomer in the composition is preferably 10 mass % or more with respect to the total mass of the composition. More preferably, the content of the urethane polymer or oligomer in the composition is 30 mass % to 80 mass %, further preferably 30 mass % to 70 mass %, particularly preferably 40 mass % to 60 mass %.

It is further preferable that the urethane polymer or oligomer of the present invention be a polymer or an oligomer having a repeating unit of the following general formula (1).

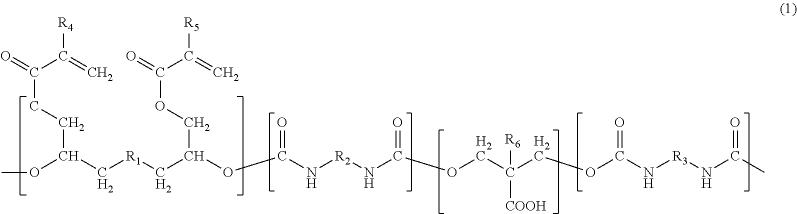

In the repeating unit of the foregoing general formula, R₁ to R₃ each independently represent an alkylene group, an arylene group, or a biarylene group, and R₄ to R₆ each independently represent a hydrogen atom, an alkyl group, an aryl group, or a heteroaryl group.

The alkylene group is preferably an alkylene group of 1 to 10 carbon atoms. The arylene group is preferably a phenylene group or a naphthylene group. The biarylene group is preferably a biphenylene group or a binaphthylene group. The alkyl group is preferably an alkyl group of 1 to 10 carbon atoms. The aryl group is preferably a phenyl group or a naphthyl group. The heteroaryl group is preferably a pyridyl group.

For example. UN-1225 (manufactured by Negami Chemical Industrial Co., Ltd.), and CN962, CN965, CN971 (manufactured by Sartomer) may preferably be used as the urethane polymer or oligomer of the foregoing general formula (1).

The content of the polymerizable compound in the composition is preferably 60 mass % to 100 mass % with respect to the total mass of the composition. The content of the oligomer or polymer compound in the composition is preferably 5 mass % to 50 mass % with respect to the total mass of the composition. In these content ranges, it is possible to improve compatibility with the phosphorylcholine group-containing polymers (for example, MPC polymers) by covalent bonding or hydrogen bonding interaction, and to desirably suppress defects such as a cohesive failure inside the material due to intermolecular cohesive force.

### (Solvent)

In the present invention, the composition containing a polymerizable compound or an oligomer or polymer compound may use a solvent to provide a preferred form for the production of the composition gradient film.

The solvent preferred for use in the composition containing a compound having a phosphorylcholine group as described above can be used as the solvent.

### Additive

The various components that may be contained in the composition containing a compound having a phosphorylcholine group as described above may be contained as additives in the composition containing a polymerizable compound or an oligomer or polymer compound.

### Interpenetrating Network Structure (IPN Structure)

It is preferable in the present invention that the compound having a phosphorylcholine group have a polymerizable functional group, and that the polymerizable compound or the oligomer or polymer compound has a polymerizable functional group. In this way, an interpenetrating network structure (IPN structure) can be formed upon the crosslinking of the compound having a phosphorylcholine group with the polymerizable compound or the oligomer or polymer compound via the polymerizable functional groups at the interface of 1) and 2) in forming the biocompatible member of the present invention.

The IPN structure formed in the biocompatible member makes it possible to develop strong interaction for the crosslinked polymer chains not by chemical bonding but by network formation, and can thus realize high water resistance, and suppress defects such as a cohesive failure inside the material due to intermolecular cohesive force.

### Base Material

The base material used in the present invention is not particularly limited, and high-strength materials such as metals, alloys, and ceramics may preferably be used for medical applications.

Examples of the metals include titanium (Ti), and chromium (Cr). Examples of the alloys include stainless steel, Cr alloys, and Ti alloys.

Specifically, preferred as Cr alloys are nickel-chromium alloys (Ni—Cr alloys), cobalt-chromium alloys (Co—Cr alloys), and cobalt-chromium-molybdenum alloys (Co—Cr—Mo alloys).

Preferred examples of the Ti alloys include Ti-6Al-4V alloys, Ti-15Mo-5Zr-3Al alloys, Ti-6Al-7Nb alloys. Ti-6Al-2Nb-1Ta alloys, Ti-15Zr-4Nb-4Ta alloys. Ti-15Mo-5Zr-3Al alloys, Ti-13Nb-13Zr alloys, Ti-12Mo-6Zr-2Fe alloys, Ti-15Mo alloys, and Ti-6Al-2Nb-1Ta-0.8Mo alloys.

Examples of the ceramics include alumina, zirconia, and titania.

### [Composition Gradient Film]

The biocompatible member according to the present invention includes a composition gradient film provided on a base material and containing the 1) and 2) above. The composition of 1) and 2) in the composition gradient film continuously varies in such a manner that the proportion of 1) increases and the proportion of 2) decreases from the side closest to the base material to the side farthest from the base material along the film thickness direction.

In the present invention, the thickness of the composition gradient film is not particularly limited, and is preferably 1 μm or more, more preferably 1 μm to 20 μm, further preferably 5 μm to 15 μm. The biocompatible member can have desirable biocompatibility in these film thickness ranges.

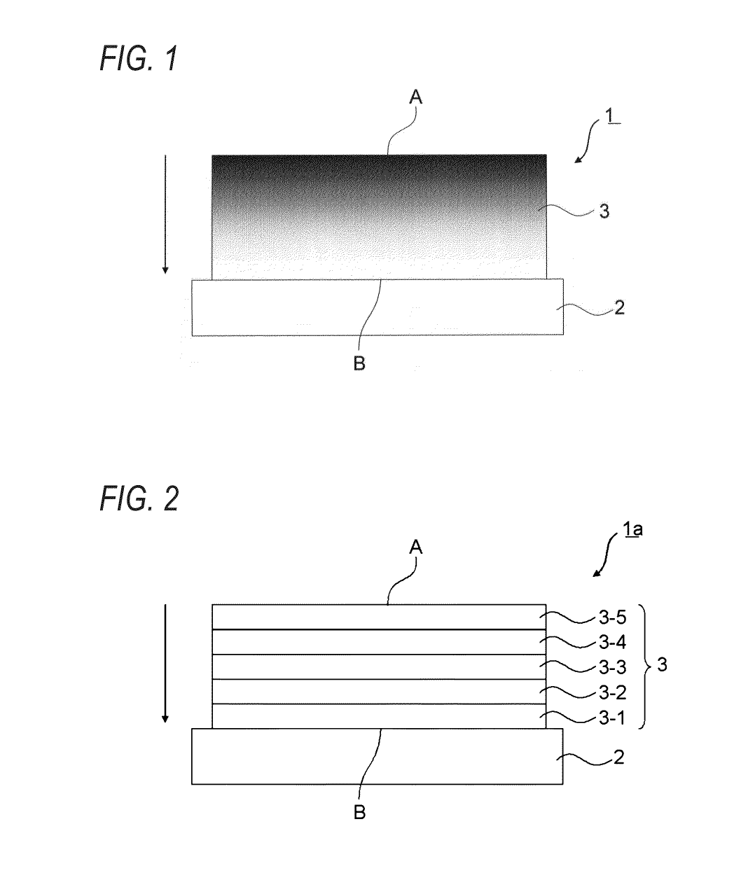

FIG. 1 schematically represents a cross section of a biocompatible member formed in the present invention.

The biocompatible member 1 according to the present invention has a pattern of a composition gradient film 3 on a base material 2. In the composition gradient film 3, the composition continuously varies toward the side B closest to the base material 2 away from the side A farthest from the base material along the thickness direction (specifically, in the direction of arrow in FIG. 1) from 1) the compound having a phosphorylcholine group to 2) the polymer of a polymerizable compound or the oligomer or polymer compound. (In other words, the composition varies in such a manner that the proportion of 1) increases and the proportion of 2) decreases from the side closest to the base material to the side farthest from the base material along the film thickness direction.)

As used herein, “thickness direction” means the direction along the thickness of the composition gradient film 3.

“The composition of 1) and 2) continuously varies in such a manner that the proportion of 1) increases and the proportion of 2) decreases from the side closest to the base material to the side farthest from the base material along a film thickness direction” means that, when the composition gradient film is divided in every region with a certain thickness (for example, 0.1 to 5 μm) along the thickness direction, the proportion of the mass of 1) the compound having a phosphorylcholine group (hereinafter referred to as “the content rate of the compound having a phosphorylcholine group”) with respect to the total mass of 1) the compound having a phosphorylcholine group, and 2) the polymer of a polymerizable compound or the oligomer or polymer compound (hereinafter, also referred to simply as “resin 2)”) in each region is measured, the difference of the content rate of the compound having a phosphorylcholine group between the adjacent regions is 1% to 50%, preferably 1% to 30%. The content variation of 1) and 2) becomes stepwise, and high adhesion and high biocompatibility cannot be obtained when the difference of the content rate of the compound having a phosphorylcholine group between the adjacent regions exceeds 50%.

From the standpoint of obtaining high biocompatibility, it is preferable that the content ratio of the compound having phosphorylcholine group on side A farthest from the base material of the composition gradient film 3 (for example, the content ratio of the compound having a phosphorylcholine group in a 0.1 to 5 μm region from side A along the film thickness) is 50% to 10) %, more preferably 70% to 100%, further preferably substantially 100% (99.8% to 100%).

Further, from the standpoint of obtaining high adhesion, it is preferable that the content ratio of the resin 2) on side B closest to the base material (for example, the content ratio of the resin 2) in a 0.1 to 5 μm region from side B along the film thickness) is 50% to 100%, more preferably 70% to 100%, further preferably substantially 100% (99% to 100%).

In the present invention, it is preferable that the composition gradient film 3 has a thickness of 1 μm or more, and that, when the proportion of the mass of 1) the compound having a phosphorylcholine group with respect to the total mass of 1) the compound having a phosphorylcholine group, and 2) the polymer of a polymerizable compound or the oligomer or polymer compound in the composition gradient film is measured in every 0.1-μm regions away from the side closest to the base material along the film thickness direction, the difference of the proportion in the adjacent measurement positions is 1% to 50% at each measurement point.

It is further preferable that the difference of the proportion is 1% to 30% at each measurement point.

The content ratio of the compound having a phosphorylcholine group in each region can be determined from, for example, the profile in a depth direction of XPS.

The configuration of the composition gradient film 3 is not particularly limited, as long as the content of the resin 2) continuously varies (in other words, as long as the content ratio of the compound having a phosphorylcholine group continuously varies). As a preferred example, the composition gradient film 3 may be configured as a laminate of multiple layers in which the content ratio of the resin 2) is different, as represented in FIG. 2.

The biocompatible member 1a represented in FIG. 2 has a composition gradient film 3 provided on the base material 2 and including a plurality of layers 3-1, 3-2, 3-3, 3-4, and 3-5 in which the content ratio of the resin 2) is different. The content of the resin 2) in the layers 3-1, 3-2, 3-3, 3-4, and 3-5 continuously increase within a range of 0% to 100% from the layer 3-5 on side A farthest from the base material 2 to the layer 3-1 on side B closest to the base material 2 (specifically, in the direction of arrow in FIG. 2).

For desirable adhesion and biocompatibility, the different of the content ratio of the resin 2) between the adjacent two layers in the layers 3-1, 3-2, 3-3, 3-4, and 3-5 is 50% or less, preferably 30% or less. Further, the content ratio of the resin 2) in the layer 3-5 on side A farthest from the base material 2 is preferably 0% to 20%, more preferably 0% to 15%. The content ratio of the resin 2) in the layer 3-1 on side B closest to the base material 2 is preferably 80% to 100%, more preferably 85% to 100%.

Though the composition gradient film 3 is formed as a laminate of the layers 3-1, 3-2, 3-3, 3-4, and 3-5 in FIG. 2, the number of laminated layers is not particularly limited, and is preferably 3 to 10, more preferably 3 to 7, particularly preferably 5 to 7. The thickness of each layer is preferably 0.1 to 5 μm, more preferably 0.3 μm to 3 μm. The thickness of each layer is preferably substantially the same (an error of the thickness is within ±0.5 μm).

In addition, in the absence of a distinct layer interface, each 0.1- to 5-μm region parted along the thickness direction of the composition gradient film 3 may be regarded as a layer.

The content ratio of the compound having a phosphorylcholine group in each region can be determined from, for example, the profile of a depth direction of XPS.

The present invention is also concerned with a method for forming the biocompatible member. The method includes ejecting on the base material at least two ink compositions including an ink composition containing the compound having a phosphorylcholine group, and an ink composition containing the polymerizable compound or the oligomer or polymer compound, using an inkjet method.

The inks used in the present invention are described below.

### (Ink Composition)

The ink compositions used in the present invention are broadly classified into an ink composition containing the compound having a phosphorylcholine group, and an ink composition containing the polymerizable compound or the oligomer or polymer compound. The ink compositions may contain the polymerization initiators, the photosensitizers, the solvents, and the additives above, and other additives such as a binder component, in addition to the compound having a phosphorylcholine group, and the polymerizable compound or the oligomer or polymer compound.

The ink compositions may be used as inks either individually or as a mixture of two or more.

In addition, in the ink composition containing the compound having a phosphorylcholine group, the compound having a phosphorylcholine group may be a monomer or a polymer thereof, as described above. However, from the standpoint of ink ejectability, the compound having a phosphorylcholine group is preferably a monomer.

### (Ink)

Two or more inks including an ink which is the ink composition containing the compound having a phosphorylcholine group, and an ink which is the ink composition containing the polymerizable compound or the oligomer or polymer compound may be independently used in the present invention as the inks used in the present invention. Alternatively, an ink which is the ink composition containing the compound having a phosphorylcholine group, and an ink which is the ink composition containing the polymerizable compound or the oligomer or polymer compound may be used as a mixed ink by being mixed.

The inks may contain a solvent, a binder component, or other additives, in addition to the compound having a phosphorylcholine group, and the polymerizable compound or the oligomer or polymer compound.

The content of the compound having a phosphorylcholine group in the ink is preferably 40 mass % to 100 mass % with respect to the total mass in the ink when the compound having a phosphorylcholine group is a monomer, and is preferably 5 mass % to 50 mass % with respect to the total mass in the ink when the compound having a phosphorylcholine group is a polymer. Sufficient antithrombogenicity and anti-cell and anti-protein adsorption can be developed in these ranges.

The content of the polymerizable compound in the ink is preferably 60(mass % to 100 mass % with respect to the total mass in the ink. The content of the oligomer or polymer compound in the ink is preferably 5 mass % to 50 mass % with respect to the total mass in the ink. Stable inkjet ejectability can be imparted in these ranges.

### Solvent

The ink according to the present invention may be prepared by mixing the compound having a phosphorylcholine group, and the polymerizable compound or the oligomer or polymer compound with a solvent.

The solvent may be appropriately selected from water and organic solvents. Preferably, the solvent is a liquid having a boiling point of 50° C. or higher, more preferably an organic solvent having a boiling point of 60° C. to 300° C. The solvent is used in such a proportion that the solid content in the ink becomes preferably 1 to 70 mass %, more preferably 5 to 60 mass %. In these ranges, the product ink can have a viscosity that provides desirable workability.

Examples of the solvent include alcohols, ketones, esters, nitriles, amides, ethers, etheresters, hydrocarbons, and halogenated hydrocarbons. Specific examples include alcohols (for example, methanol, ethanol, propanol, butanol, benzyl alcohol, ethylene glycol, propylene glycol, ethylene glycol monoacetate, and cresol), ketones (for example, methyl ethyl ketone, methyl isobutyl ketone, cyclohexanone, and methylcyclohexanone), esters (for example, methyl acetate, ethyl acetate, propyl acetate, butyl acetate, ethyl formate, propyl formate, butyl formate, and ethyl lactate), aliphatic hydrocarbons (for example, hexane, and cyclohexane), halogenated hydrocarbons (for example, methylene chloride, and methylchloroform), aromatic hydrocarbons (for example, toluene, and xylene), amides (for example, dimethylformamide, dimethylacetoamide, and n-methylpyrrolidone), ethers (for example, dioxane, tetrahydrofuran, ethylene glycol dimethyl ether, and propylene glycol dimethyl ether), ether alcohols (for example, 1-methoxy-2-propanol, ethyl cellosolve, and methyl carbinol), and fluoroalcohols (for example, the compounds listed in JP-A-8-143709, paragraph (00201, and in JP-A-11-60807, paragraph [0037]).

These solvents may be used either individually or as a mixture of two or more. Examples of the preferred solvents include toluene, xylene, methyl ethyl ketone, methyl isobutyl ketone, cyclohexanone, methanol, isopropanol, and butanol.

### (Additive)

The ink according to the present invention may contain additives such as complexing agents, dispersants, surface tension adjusters, anti-fouling agents, water resistance imparting agents, and chemical resistance imparting agents, in addition to the materials 1) and 2) above.

Preferably, a complexing agent and a dispersant are used when the ink contains metal. Examples of the complexing agent include carboxylic acids such as acetic acid and citric acid, diketones such as acetylacetone, and amines such as triethanolamine. Examples of the dispersant include amines such as stearylamine, and laurylamine.

### (Ink Properties)

From the standpoint of uniform deposition, inkjet ejection stability, and ink preservation stability, the viscosity of the ink according to the present invention is preferably 5 to 40 cP, more preferably 5 to 30 cP, and further preferably 8 to 20 cP.

Further, from the standpoint of uniform deposition, inkjet ejection stability, and ink preservation stability, the surface tension of the ink is preferably 10 to 40 mN/m, more preferably 15 to 35 mN/m, further preferably 20 to 30 mN/m.

### (Production of Composition Gradient Film by Inkjet Method)

The following describes production of the composition gradient film of the present invention by an inkjet method.

In the present invention, two or more independent inks including an ink which is the ink composition containing the compound having a phosphorylcholine group, and an ink which is the ink composition containing the polymerizable compound or the oligomer or polymer compound are ejected onto a base material by using an inkjet method. Alternatively, an ink which is the ink composition containing the compound having a phosphorylcholine group, and an ink which is the ink composition containing the polymerizable compound or the oligomer or polymer compound are mixed, and the mixed ink is ejected onto a base material by using an inkjet method.

The inkjet method is not particularly limited, as long as an image is recorded with an inkjet printer, and may be performed by using known methods, including, for example, the charge control method in which an ink composition is ejected by using an electrostatic attraction force, the drop on-demand method (pressure pulse method) that makes use of the oscillation pressure of a piezoelectric element, the acoustic inkjet method in which an ink composition is ejected by using radiation pressure through irradiation of the ink composition with an acoustic beam produced by conversion from electrical signals, and the thermal inkjet (Bubble Jet®) method that uses the generated pressure of the bubbles formed by heating an ink composition.

Ink droplets are controlled mainly by a print head. For example, in the case of the thermal inkjet method, the discharge amount of droplet can be controlled by the print head structure. Specifically, droplets can be discharged in desired sizes by varying the size of the ink chamber, the heating unit, or the nozzles. It is also possible in the thermal inkjet method to discharge droplets in different sizes by providing a plurality of print heads having heating units and nozzles of different sizes. The discharge amount also can be varied by varying the print head structure in the drop on-demand method that uses a piezoelectric element, as with the case of the thermal inkjet method. However, droplets of different sizes also can be discharged even with the print heads of the same structure by controlling the waveform of the drive signal for driving the piezo element.

As a method for ejecting (drawing) the ink onto the base material, a mixed drawing method in which the ink containing the ink composition containing the compound having a phosphorylcholine group, and the ink containing the ink composition containing the polymerizable compound or the oligomer or polymer compound are supplied to different inkjet heads, and simultaneously ejected in adjusted ejection amount proportions so as to mix the inks on the base material can be exemplified. Alternatively, as a method other than it, a mixed ink method may be used in which the ink containing the ink composition containing the compound having a phosphorylcholine group, and the ink containing the ink composition containing the polymerizable compound or the oligomer or polymer compound are mixed to prepare a plurality of mixed inks of different proportions, and in which these mixed inks containing different proportions of the ink containing the ink composition containing the compound having a phosphorylcholine group, and the ink containing the ink composition containing the polymerizable compound or the oligomer or polymer compound are supplied to inkjet heads, and the heads are selected in order and the mixed inks different in the proportions of the ink containing the ink composition containing the compound having a phosphorylcholine group, and the ink containing the ink composition containing the polymerizable compound or the oligomer or polymer compound are successively ejected for drawing.

### Ink Preparation

The following describes preparation of the ink which is the ink composition containing the compound having a phosphorylcholine group, and the ink which is the ink composition containing the polymerizable compound or the oligomer or polymer compound used in the mixed drawing method.

The inks may be prepared by mixing the materials. The materials may be agitated with an agitator while being mixed. The agitation time is not particularly limited, and is typically 30 to 60 min, preferably 30 to 40 min. The mixing temperature is typically 10° C. to 40° C., preferably 20° C. to 35° C.

The inks prepared as above may be mixed and used in the mixed ink method described later.

### Mixed Drawing Method

Preferably, the method according to the present invention is a method by which the biocompatible member having a composition gradient film is formed on a base material, wherein the composition of 1) and 2) in the composition gradient film continuously varies in such a manner that the proportion of 1) the compound having a phosphorylcholine group increases and the proportion of 2) the polymer of a polymerizable compound, or the oligomer or polymer compound decreases from the side closest to the base material to the side farthest from the base material along the film thickness direction.

The method forms the composition gradient film on the base material by ejecting at least two ink compositions including an ink composition containing the compound having a phosphorylcholine group, and an ink composition containing the polymerizable compound or the oligomer or polymer compound by using an inkjet method,

wherein the ink composition containing the compound having a phosphorylcholine group, and the ink composition containing the polymerizable compound or the oligomer or polymer compound are used as at least two of the ink compositions, and

wherein the inkjet method uses at least a first inkjet head and a second inkjet head, and the method includes:

a step of supplying the ink composition containing the compound having a phosphorylcholine group to the first inkjet head as a first ink;

a step of supplying the ink composition containing the polymerizable compound or the oligomer or polymer compound to the second inkjet head as a second ink;

a control step of deciding the proportion of the amount of the first ink ejected from the first inkjet head and the proportion of the amount of the second ink ejected from the second inkjet head;

a forming step of forming a single layer by ejecting the first ink or the second ink from at least one of the first inkjet head and the second inkjet head according to the decided proportions; and

a laminate step of repeating the forming step to laminate a plurality of layers on the base material and obtain the composition gradient film,

wherein in the control step the proportions are decided in such a manner that the proportion of the first ink increases and the proportion of the second ink decreases from the side closest to the base material to the side farthest from the base material along the thickness direction of the plurality of layers.

According to the foregoing drawing method, the proportion of the ejection amount of the first ink ejected from the first inkjet head and the ejection amount of the second ink ejected from the second inkjet head is decided, a plurality of layers is formed on the base material by repeatedly forming a single layer with the first ink and the second ink ejected according to the decided proportions from the first inkjet head and the second inkjet head, respectively. The plurality of layers is formed in such a manner that the proportion of the ejection amount of the first ink becomes greater and the proportion of the ejection amount of the second ink becomes smaller in the upper layers. In this way, the composition gradient film can be produced by using the inkjet technique.

Note that the present invention is also concerned with a biocompatible member formed by the foregoing drawing method.

### Embodiment of Mixed Drawing Method

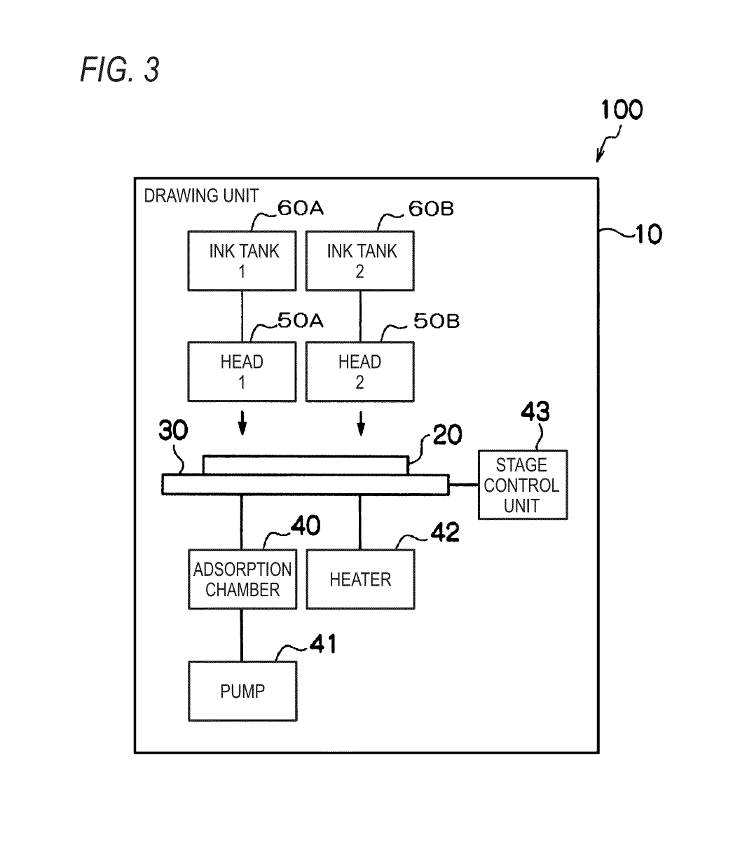

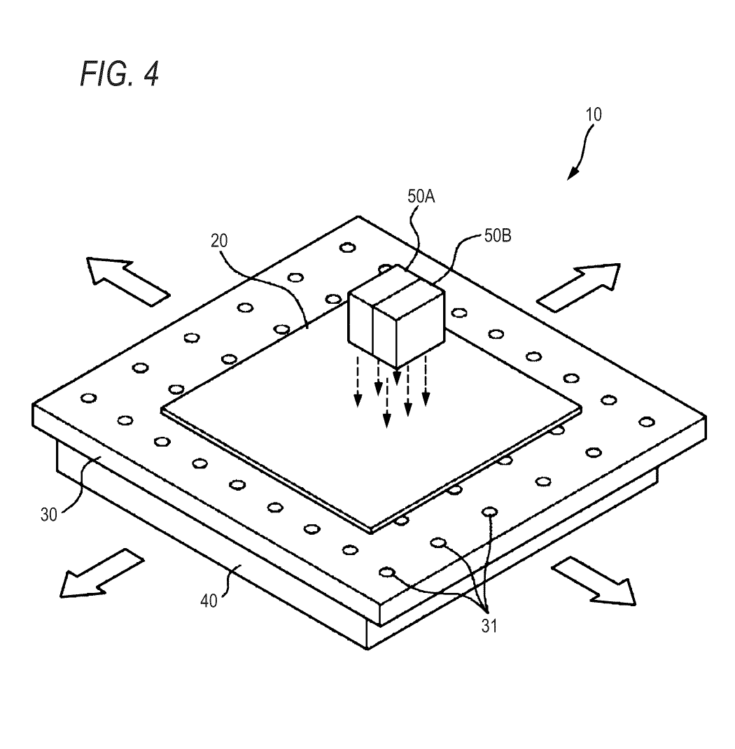

FIG. 3 is an overall block diagram representing a composition gradient film producing apparatus 100 used in the mixed drawing method. FIG. 4 is a schematic diagram of a drawing unit 10 of the composition gradient film producing apparatus 100. As represented in these figures, the composition gradient film producing apparatus 100 is configured to include the drawing unit 10, and a flathead-type inkjet drawing device is used for the drawing unit 10. Specifically, the drawing unit 10 is configured to include a stage 30 on which a base material is mounted, an adsorption chamber 40 used to adsorb and hold the base material mounted on the stage 30, and an inkjet head 50A (hereinafter, “inkjet head 1”) and an inkjet head 50B (hereinafter, “inkjet head 2”) for ejecting inks onto a base material 20.

The stage 30 has a width dimension wider than the diameter of the base material 20, and is configured to be freely movable along a horizontal direction with a movement mechanism (not illustrated). The movement mechanism may be, for example, a rack-and-pinion mechanism, or a ball screw mechanism. A stage control unit 43 (not illustrated in FIG. 4) controls the movement mechanism to move the stage 30 to a desired position.

The stage 30 has large numbers of suction holes 31 on the surface holding the base material 20. The adsorption chamber 40 is provided on the lower surface of the stage 30. The base material 20 on the stage 30 is held in place as the adsorption chamber 40 is vacuumed with a pump 41 (not illustrated in FIG. 4). The stage 30 is also provided with a heater 42 (not illustrated in FIG. 4). The heater 42 can heat the base material 20 adsorbed and held to the stage 30.

The inks supplied from ink tanks 60A (hereinafter, “ink tank 1”) and an ink tank 60B (hereinafter, “ink tank 2”) are ejected by the inkjet heads 1 and 2 to a desired position on the transparent base 20. Here, heads with piezo actuators are used as the inkjet heads 1 and 2. The inkjet heads 1 and 2 are fixed as closely as possible using fixing means (not illustrated).

The inks supplied from the ink tanks 1 and 2 to the inkjet heads 1 and 2 are referred to as inks 1 and 2, respectively. In the present invention, the ink 1 is an ink containing an ink composition containing the compound having a phosphorylcholine group (hereinafter, also referred to as “biocompatible ink”), and the ink 2 is an ink containing an ink composition containing the polymerizable compound or the oligomer or polymer compound (hereinafter, also referred to as “adhesion ink”).

### [Production of Composition Gradient Film Using Mixed Drawing Method]

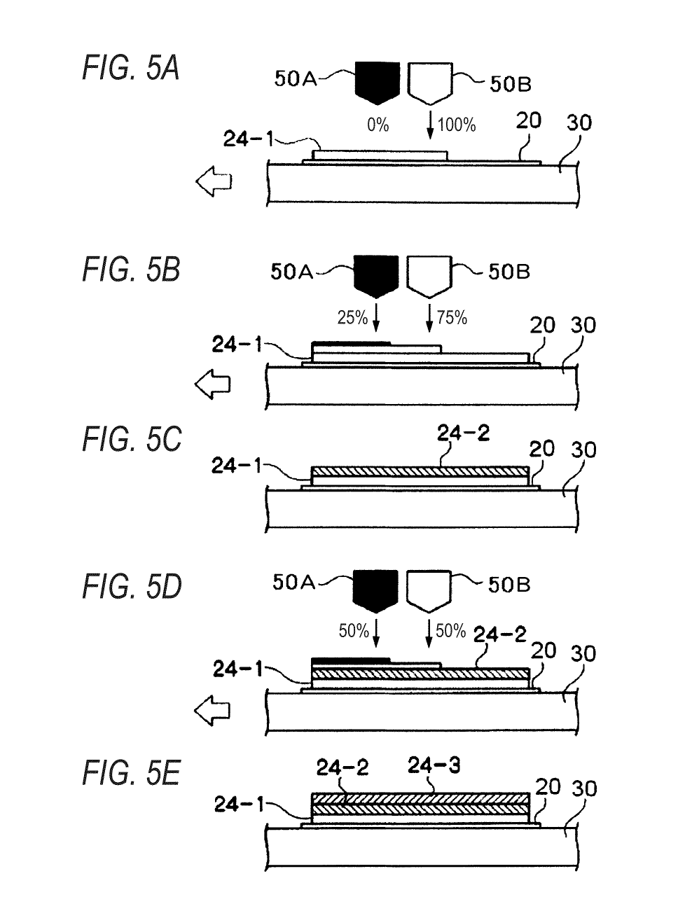

With reference to FIG. 5, the following describes production of the composition gradient film using the composition gradient film producing apparatus 100 configured as above.

First, the base material 20 is mounted on the stage 30 of the drawing unit 10 in a nitrogen atmosphere. The base material 20 is mounted with its back surface in contact with the stage 30. Adsorption of the base material 20 to the stage 30 and heating are conducted with the adsorption chamber 40. Preferably, the base material 20 is heated to 70° C.

Thereafter, the ink (ink 2) supplied from the inkjet head 2 is laminated in a single layer or several layers to form a layer 24-1 on the base material 20 adsorbed and heated as above. The ink 2 is laminated by being ejected through the inkjet head 2 while moving the stage 30 with the movement mechanism, as illustrated in FIG. 5A (to the left in the figure). Here, no ink is ejected from the inkjet head 1.

Here, it is preferable to dry (semi-dry, partially cure) the layer 24-1 of the ink 2 to such an extent that the solvent component in the ink 2 does not completely evaporate, or that the polymerizable (curable) compound in the ink 2 does not completely polymerizes (cures). Specifically, the ink is dried with less energy than that used for normal drying (complete drying, complete cure).

In addition, in the descriptions of the present invention, “semi-drying” and “complete drying” also mean “partial cure” and “complete cure” when a curable composition such as a polymerizable (curable) compound is used as the ink of the present invention.

In the present invention, it is preferable to include the step of semi-drying the layer ejected in the forming step. For semi-drying, for example, it is preferable to maintain the ambient temperature at 40 to 120° C., more preferably 50 to 100° C. for a certain time period after the ejection. Preferably, the temperature is maintained for 10 to 120 seconds, more preferably 20 to 90 seconds.

Thereafter, a mixed layer 24-2 of the inks 1 and 2 is formed on the layer 24-1 of the ink 2 which becomes a semi-dryed state. As illustrated in FIG. 5B, the mixed layer 24-2 is formed by simultaneously ejecting the ink 1 from the inkjet head 1 and the ink 2 from the inkjet head 2 while moving the stage 30. Here, the ejection amounts of the inks 1 and 2 are adjusted to desired proportions. In this example, the ejection amounts through the respective nozzles are adjusted to 75% for the ink 2 and 25% for the ink 1 and the inks are ejected. In addition, the “ejection amount” as used herein means the total amount of the ink ejected to form each layer. On the other hand, the “droplet amount” of the ink droplet ejected from the inkjet head means the amount of a single ink droplet, as will be described later.

The proportions of the ink ejection amounts from the inkjet heads 1 and 2 may be adjusted according to the drawing dot pitch density. For example, the proportions of the ejection amounts may be adjusted by controlling the number of ejection nozzles to make the nozzle ratio 75:25 for the inkjet heads 1 and 2, with the ejection amounts from the respective nozzles of the inkjet heads 1 and 2 being held constant.

After the ink ejection, as illustrated in FIG. 5C, the inks 1 and 2 ejected in the adjusted ejection amounts are diffused and mixed to laminate a mixed layer 24-2. Because the layer 24-1 of the ink 2 is semi-dried, the solvent in the ink forming the mixed layer 24-2 thereon is allowed to move into the layer 24-1 of the ink 2, and does not overly wet and spread. It is therefore required to adjust the heat temperature in the heater 42 according to the ease of ink evaporation. Depending on the type of the solvent used, drawing may be performed at temperatures below 70° C., for example, at a base temperature of about 50° C.

Specifically, the forming step preferably includes the step of diffusing and mixing the ejected first and second inks. The inks may be diffused and mixed, for example, by using a method that takes advantage of convention by heating, or a method that uses ultrasonic waves.

The two inkjet heads are disposed as closely as possible, so as to prevent drying of only one of the inks and insufficient mixing of the inks in a layer. In the simultaneous ejection of the two inks, the droplets of the inks 1 and 2 ejected from the inkjet heads 1 and 2, respectively, may be mixed by causing collisions in flight before landing.

It is preferable that each width of the two inkjet heads is greater than the width (shorter side) of the target base material, and that a single layer is formed by a single scan, as will be described layer in more detail. In this way, the inks 1 and 2 can mix more easily.

Further, in order to promote mixing of the inks, the base material 20 may be sonicated by controlling the stage 30. Here, sonication is preferably performed while sweeping the ultrasonic frequency or changing the position of the base material 20, so that nodes do not easily occur in the sonication.

Upon semi-drying the mixed layer 24-2 in the same manner as for the layer 24-1 of the ink 2, the mixed layer 24-2 becomes a 75:25 laminate mixture of the polymerizable compound or the oligomer or polymer compound contained in the ink 2, and the compound having a phosphorylcholine group contained in the ink 1.

Thereafter, a mixed layer 24-3 is formed on the mixed layer 24-2. As illustrated in FIG. 5D, the mixed layer 24-3 is formed by simultaneously ejecting the inks from the inkjet heads 1 and 2 while moving the stage 30, as above. Here, the inks 1 and 2 are ejected in 50% proportions.

Because the mixed layer 24-2 is semi-dried, the solvent in the ink forming the mixed layer 24-3 thereon is allowed to move into the mixed layer 24-2. After the ink ejection, the two inks are diffused and mixed to laminate the mixed layer 24-3, as illustrated in FIG. 5 (e).

The mixed layer 24-3 is semi-dried in the same manner as for the layer 24-1 of the ink 2. As a result, the mixed layer 24-3 becomes a 50:50 laminate mixture of the polymerizable compound or the oligomer or polymer compound contained in the ink 2, and the compound having a phosphorylcholine group contained in the ink 1.

In this manner, the ejection amounts of the inks 1 and 2 are varied in a step-by-step manner (so as to be grade) to form the mixed layers, and the final layer is formed with the 100% ejection amount for the ink 1.

After the formation of all the layers, diffusion proceeds in each layer, and the layers formed in a step-by-step manner become continuous. As a result, as represented in FIG. 1, the composition gradient film 3 is formed in which the proportion of the ink 1 in the composition approaches 100% toward side A along the film thickness direction from side B where the proportion of the ink 2 is 100%.

In this manner, the upper layers are formed on the semi-dried lower layers to allow for some diffusion between the upper and lower layers. Here, it is preferable that the layers be formed without being completely mixed, so that a layer interface and a boundary remain between the upper and lower layers.

After the formation of all the layers, a dummy pattern may be laminated in a non-functioning region of the composition gradient film, and the height of the dummy pattern may be measured with a device such as an optical displacement sensor that uses a laser. The thickness is measured high when drying did not proceed and the solvent remains. The state of drying can thus be detected by the height of the dummy pattern.

As described above, the composition gradient film can be formed by using inkjet heads. Another advantage of the mixed drawing method of the present embodiment is that fewer inks and inkjet heads are used, regardless of the number of layers formed. The number of the mixed layers of ink 1 and ink 2 is not limited, as long as the layers are formed in graded ink mixture ratios in a step-by-step manner.

From the standpoint of controlling the film thickness and forming thin lines, the amount of the ink droplet ejected from the first inkjet head and the second inkjet head in the forming step of each layer is preferably 0.3 to 100 pL, more preferably 0.5 to 80 pL, further preferably 0.7 to 70 pL.

From the standpoint of controlling the film thickness and forming thin lines, the size of the ink droplet ejected from the first inkjet head and the second inkjet head in the forming step of each layer is preferably 1 to 300 μm, more preferably 5 to 250 μm, further preferably 10 to 200 μm.

Further, in the forming step of each layer, it is preferable that whichever of the first ink and the second ink ejected in a smaller proportion is ejected in a smaller droplet amount and/or in a smaller droplet size from the inkjet head than that of the ink ejected in a greater proportion. For example, the droplet of the ink ejected in a smaller proportion is preferably 0.3 to 60 pL, and the droplet of the ink ejected in a greater proportion is preferably 1 to 100 pL. In this way, the diffusion and mixing time can be reduced, and the uniformity of the mixture can be improved.

In addition, the “size” of an ink droplet means the length of diameter of an ink droplet, and can be measured from a photograph of the ejected inkjet ink in flight.

In the present embodiment, the composition gradient film 3 is formed to make the ink 1 approach 100% toward side A away from side B where the ink 2 is 100%. However, it is not necessarily required to form a film in which the ink 2 or ink 1 reaches 100% on side B or side A, and the ink 2 and ink 1 may have any proportions on side B or side A, as long as the composition gradient film 3 is obtained.

The proportion of the ink 2 or ink 1 on side B or side A may be appropriately adjusted according to the properties, including the adhesion and the biocompatibility of the intended composition gradient film.

Further, the inks may be ejected in order from the inkjet heads 1 and 2 to form each layer, instead of being simultaneously ejected as in the present embodiment.

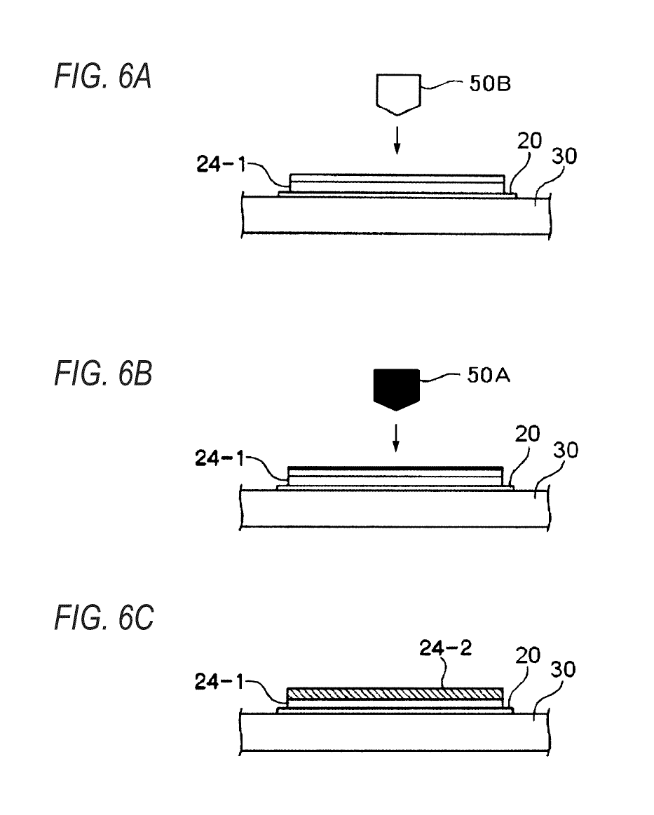

For example, as illustrated in FIG. 6A, the mixed layer 24-2 is formed by first ejecting the ink 2 over the whole surface of the layer 24-1 of the ink 2 from the inkjet head 2. Then, as illustrated in FIG. 6B, the ink 1 is ejected over the whole surface from the inkjet head 1. These inks are then diffused and mixed to form the mixed layer 24-2, as illustrated in FIG. 6C.

In forming a single layer by ejecting the inks in order as above, the ink of a greater proportion may be ejected first when the inks are ejected in different amounts, specifically when the proportions of the ejected inks are not 50%. It is preferable to eject the ink of a greater proportion first, particularly when the ink ejected first dries rapidly, because the drying proceeds more quickly in smaller amounts. In this way, mixing of the two kinds of inks can proceed more smoothly.

Further, in this case, the ink ejected later in a smaller amount may be ejected in smaller droplets (in smaller droplet amounts or smaller droplet sizes) to increase the dot pitch density. In this way, the time of diffusion and mixing can be reduced.

Further, the ink ejected later may be ejected to land on the ink ejected and landed first. Particularly, when the ink is expelled intermittently and the dots are distant apart, the mixing of the inks can be facilitated by ejecting the ink to land on the same positions before drying takes place.

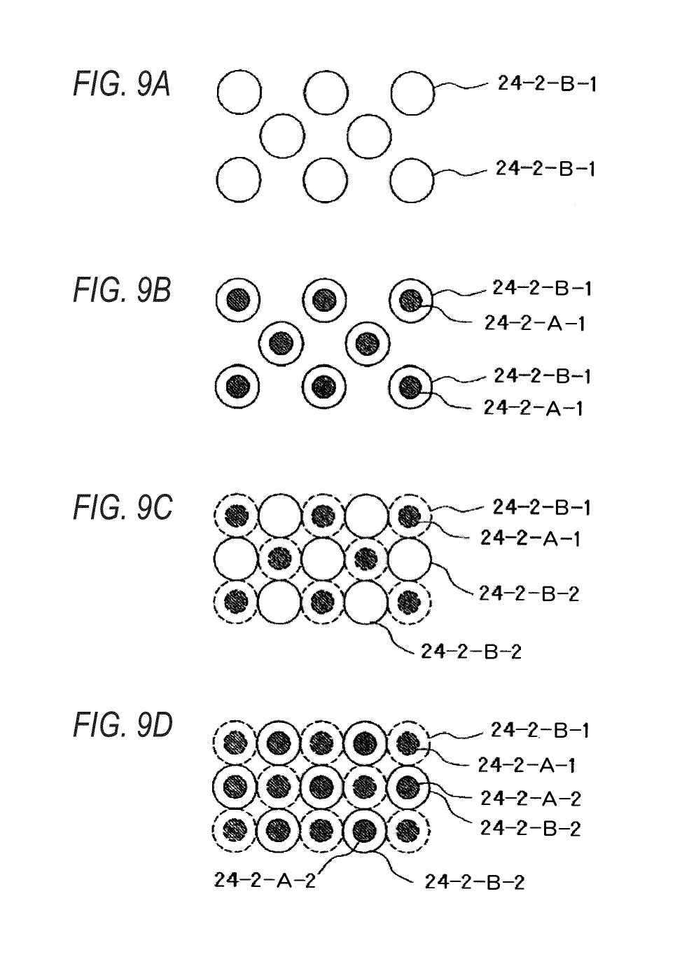

For example, assume that the ink 2 is intermittently ejected from the inkjet head 2 in the first scan to form the mixed layer 24-2. FIG. 9A represents ink 2 (24-2-B-1) landed on the layer 24-1 of the ink 1.

In the second scan, the ink 1 is intermittently ejected from the inkjet head 1. Here, as illustrated in FIG. 9B, the inkjet head 1 ejects the ink 1 (24-2-A-1) to land on the same positions where the ink 2 (24-2-B-1) has landed in the first scan.

Further, in the third scan, the ink 2 is intermittently ejected from the inkjet head 2. FIG. 9C represents the ink 2 (24-2-B-2) landed between the ink 2 (24-2-B-1).

In the fourth scan, the inkjet head 1 ejects the ink 1 to land on the same positions where the ink 2 (24-2-B-2) has landed. As illustrated in FIG. 9D, the ejected ink 1 (24-2-A-2) lands on the same positions where the ink 2 (24-2-B-2) has landed in the second scan.

Subsequently, the ink is ejected over the whole surface of the layer 24-1 of the ink 1, and the inks are diffused and mixed, as above. By ejecting the inks as above, the diffusion and mixing time can be reduced in forming the mixed layer 24-2.

When one of the inks is fast drying, the fast drying ink may be ejected later.

In addition to the two pure inks 1 and 2 used to form a mixed layer in the present embodiment, a mixture of these inks may be used with the inks 1 and 2. For example, a mixed layer may be formed by simultaneously using the two pure inks with a 50:50 mixture of the inks 1 and 2. This requires an additional inkjet head for the mixed ink; however, the time required for the diffusion and the mixing of the ejected inks after ejection can be reduced, because the two pure inks in the mixed ink are sufficiently mixed already.

### Mixed Ink Method

Preferably, the method of the present invention is a method by which the biocompatible member having a composition gradient film formed on a base material, wherein the composition of 1) and 2) in the composition gradient film continuously varies in such a manner that the proportion of 1) the compound having a phosphorylcholine group increases and the proportion of 2) the polymer of a polymerizable compound, or the oligomer or polymer compound decreases from the side closest to the base material to the side farthest from the base material along the film thickness direction.

The method forms the composition gradient film on the base material by ejecting at least two ink compositions including an ink composition containing the compound having a phosphorylcholine group, and an ink composition containing the polymerizable compound or the oligomer or polymer compound by using an inkjet method,

wherein the ink composition containing the compound having a phosphorylcholine group, and the ink composition containing the polymerizable compound or the oligomer or polymer compound are used as at least two of the ink compositions, and

wherein the inkjet method uses a plurality of inkjet heads, and the method includes:

a step of supplying mixed inks to the respective inkjet heads of the plurality of inkjet heads in which the mixed inks are the mixed inks of the first ink which is an ink composition containing the compound having a phosphorylcholine group and the second ink which is an ink composition containing the polymerizable compound or the oligomer or polymer compound, and the mixed inks are different from one another in mixed proportion of the first ink and the second ink;

a selecting step of sequentially selecting an inkjet head from the plurality of inkjet heads in order of decreasing proportions of the second ink in the mixed inks;

a forming step of forming a single layer by ejecting the mixed ink from the selected inkjet head; and

a laminate step of repeating the forming step to laminate a plurality of layers on the base material and obtain the composition gradient film.

According to this method, a plurality of mixed inks in which the mixed inks are the mixed inks of the first ink and the second ink, and the mixed inks are different from one another in mixed proportion of the first ink and the second ink is supplied to their respective inkjet heads, and the mixed inks are ejected from the inkjet heads in order of increasing proportions of the first ink in the mixed inks to form each layer and laminate plurality of layers on the base material. In this way, the composition gradient film can be produced by using the inkjet technique.

In addition the present invention is also concerned with a biocompatible member formed by the foregoing drawing method.

### Embodiment of Mixed Ink Method

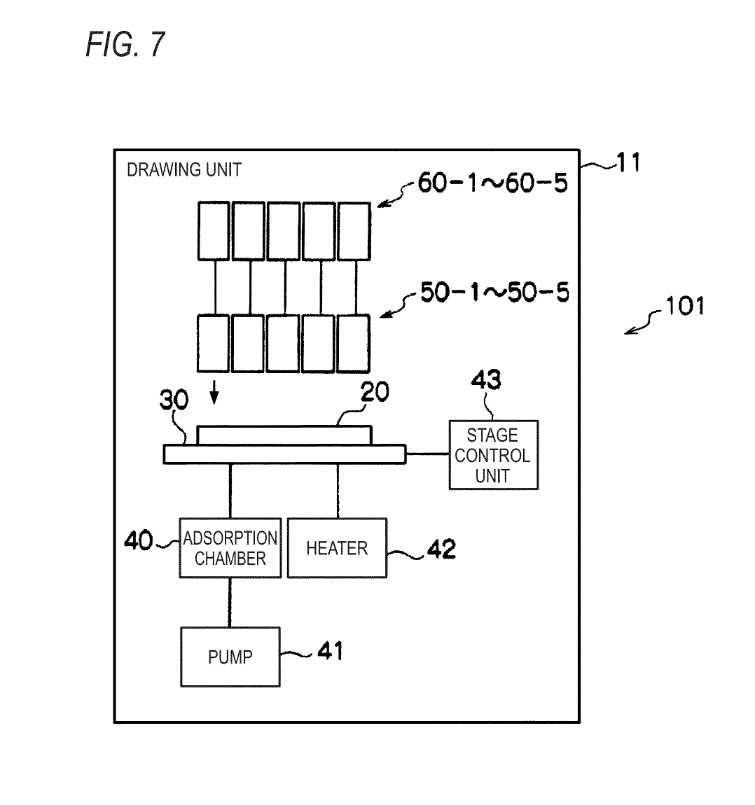

FIG. 7 is an overall block diagram of a composition gradient film producing apparatus 101 according to Second Embodiment. As represented in the figure, the composition gradient film producing apparatus 101 according to the present embodiment includes a drawing unit 11. The drawing unit 11 includes ink tanks 60-1 to 60-5 respectively storing five kinds of inks, and inkjet heads 50-1 to 50-5 to which the inks are supplied from their respective ink tanks. The inks supplied from the ink tanks 60-1 to 60-5 are ejected to a base material 20 by the inkjet heads 50-1 to 50-5.

The inks supplied to the inkjet heads 50-1 to 50-5 from the ink tanks 60-1 to 60-5 contain the ink 1 and the ink 2 at a mixture mass ratio of 0:100, 25:75, 50:50, 75:25, and 100:0, respectively. Specifically, the ink tank 60-1 supplies the pure ink 2, the ink tank 60-5 supplied the pure ink 1, and the ink tanks 60-2 to 60-4 supply mixed inks containing the ink 1 and the ink 2 in predetermined proportions.

### [Production of Composition Gradient Film by Mixed Ink Method]

The base material 20 is adsorbed and heated after being mounted on the stage 30, as in the embodiment of the mixed drawing method.

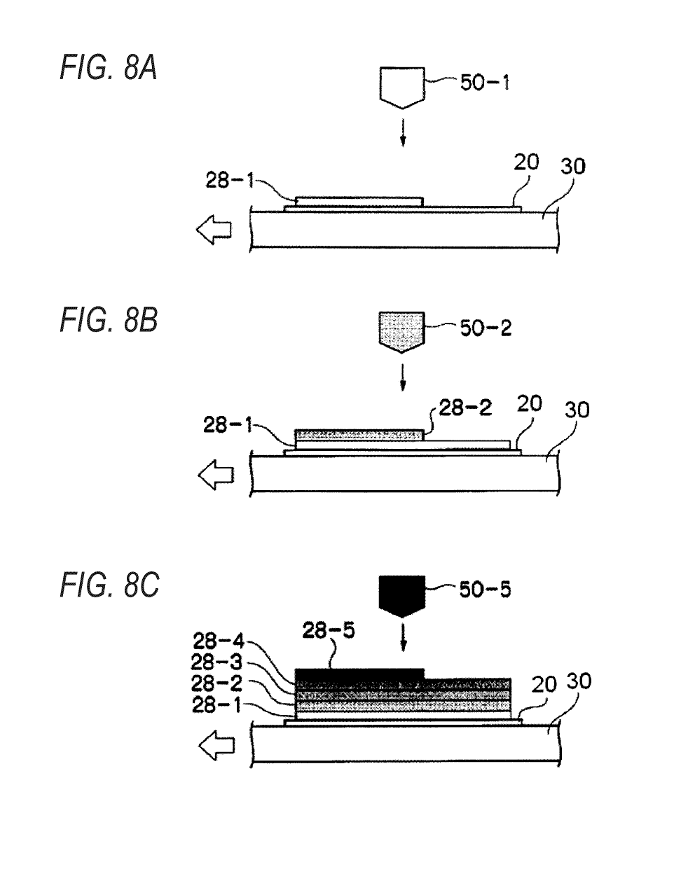

Thereafter, a layer 28-1 of the ink 2 is formed on the adsorbed and heated base material by laminating the ink 2 in a single layer or in several layers. As illustrated in FIG. 8A, the laminate of the ink 2 is formed by ejecting the ink (mixture ratio (proportion) of inks 1 and 2 is 0:100) onto the base material from the inkjet head 50-1 receiving the ink from the ink tank 60-1. The ink is ejected while moving the stage 30 with a movement mechanism (to the left in the figure). Here, the other inkjet heads 50-2 to 50-5 do not eject the inks.

The layer 28-1 of the ink 2 formed as above is similar to the layer 24-1 of the ink 2 shown in FIG. 5. Here, the compound having a phosphorylcholine group contained in the ink 1 assumes a laminated state upon drying (semi-drying, partially curing) the layer to such an extent that the solvent in the ink 2 does not completely evaporate or the curable compound in the ink 2 does not completely cure.

Preferably, the mixed ink method includes the step of semi-drying the layer ejected in the forming step of the layer. For semi-drying, for example, it is preferable to maintain an ambient temperature of 40 to 120° C., more preferably 50 to 100° C. for a certain time period after the ejection. The temperature is maintained for preferably 10 to 120 seconds, more preferably 20 to 90 seconds.

Thereafter, a mixed layer 28-2 is formed by ejecting the mixed ink (mixed ink in which the mixture ratio of the inks 1 and 2 is 25:75) onto the layer 28-1 of the ink 2 from the inkjet head 50-2 receiving the ink from the ink tank 60-2.

As illustrated in FIG. 8B, the mixed layer 28-2 is formed by ejecting the mixed ink from the inkjet head 50-2 while moving the stage 30. Because the layer 28-1 of the ink 2 is semi-dried, the solvent in the ink forming the mixed layer 28-2 thereon is allowed to move into the layer 28-1 of the ink 2, and does not overly wet and spread, as in the embodiment of the mixed drawing method. It is therefore required to adjust the heat temperature according to the ease of ink evaporation.

The compound having a phosphorylcholine group contained in the ink 1, and the polymerizable compound or the oligomer or polymer compound contained in the ink 2 assume a laminated state in the mixed layer 28-2 upon semi-drying the mixed layer 28-2.

Further, a mixed layer 28-3 is formed by ejecting the mixed ink (mixed ink in which the mixture ratio of the inks 1 and 2 is 50:50) onto the mixed layer 28-2 from the inkjet head 50-3 (not illustrated in FIG. 8) receiving the ink from the ink tank 60-3.

Because the mixed layer 28-2 is semi-dried, the solvent in the ink forming the mixed layer 28-3 thereon is allowed to move into the mixed layer 28-2. The mixed layer 28-3 is also semi-dried.

In this manner, the mixed layers (28-2 to 28-4) are laminated by ejecting the mixed inks in order of decreasing proportions of the ink 2 (in order of increasing proportions of the ink 1), and, finally, the layer 28-5 of 100% ink 1 (ink 1 layer) is formed by ejecting the ink 1 (the mixture ratio of the inks 1 and 2 is 100:0) from the inkjet head 50-5 receiving the ink from the ink tank 60-5 (FIG. 8C).

Forming all the layers completes the composition gradient film 3 containing the ink 1 and the ink 2 in 0% to (100% composition ratios, respectively, as represented in FIG. 1.

From the standpoint of stable ejection, the amount of the ink droplet ejected from the inkjet heads in the forming step of each layer is preferably 0.5 to 150 pL, more preferably 0.7 to 130 pL, further preferably 1 to 100 pL.

From the standpoint of desirable film formation, the size of the ink droplet ejected from the inkjet heads in the forming step of each layer is preferably 2 to 450 μm, more preferably 5 to 350 μm, further preferably 10 to 250 μm.

As described above, the composition gradient film can be formed by using mixed inks. In the mixed ink method of the present embodiment, the ink components are sufficiently mixed in the form of an ink, and thus the composition gradient film can be formed with high gradation accuracy. Further, by comparing the mixed ink method and the mixed drawing method described in the foregoing embodiment, the mixed ink method is more advantageous, because it does not require the time to diffuse and mix the two kinds of functional inks, and thus involves a shorter process time.

Three mixed layers of ink 1 and ink 2 are formed in the present embodiment. However, the number of layers is not limited to three, and any number of mixed layers may be formed, as long as the layers can be laminated with gradient ink mixture ratios. In addition, the ink tanks and the inkjet heads need to be provided for the number of the layers formed.

Further, the composition gradient film 3 formed in the present embodiment contains the ink 1 and the ink 2 in 0% to 100% composition ratios, respectively. However, it is not necessary to adopt the composition ratio of the ink 1 of 100% or of the ink 2 of 100%, and any composition ratio may be set, as long as the composition gradient film 3 can be obtained.

The composition ratio may be appropriately adjusted according to the properties, including the adhesion and the biocompatibility of the intended composition gradient film.

### EXAMPLES

The present invention is described below in more detail using examples. It should be noted that the following examples are not to be narrowly construed as to limit the scope of the present invention.

### Example 1-1

### Production of Ink Composition Containing Polymerizable Compound

### Curable Resin Ink; Hereinafter, “Adhesion Ink”

### Adhesion Ink A1

| | |
|---|---|
| N-Vinyl caprolactam (manufactured by SIGMA-ALDRICH) | 50 g |
| Dipropylene glycol diacrylate (manufactured by Akcros) | 40 g |
| IRGACURE 184 (manufactured by BASF) | 4 g |
| Lucirin TPO (manufactured by BASF) | 6 g |

The materials were charged into a 1-L container, and agitated with a Silverson high-speed agitator for 20 min at a maintained liquid temperature of 40° C. or less. Adhesion ink A1 was obtained after filtration through a 2-μm filter.

### Adhesion Inks A2 to A9

Adhesion inks A2 to A9 were produced in the same manner as for the adhesion ink A1, except that the N-vinyl caprolactam (monomer material (I)) and the dipropylene glycol diacrylate (monomer material (II)) in the adhesion ink A1 were replaced with the materials for constituting the adhesion ink listed in Examples 1-5 to 1-12 in Table 1 below.

### Production of Ink Composition Containing a Compound Having Phosphorylcholine Group (Curable Biocompatible Ink; Hereinafter, “Biocompatible Ink”)

### Biocompatible Ink B1

| | |
|---|---|
| 2-Methacryloyloxyethyl phosphorylcholine (MPC) | 80 g |
| Diethylene glycol diacrylate (manufactured by Akcros) | 0 g |
| IRGACURE 184 (manufactured by BASF) | 4 g |
| Lucirin TPO (manufactured by BASF) | 6 g |

The materials were charged into a 1-L container, and agitated with a Silverson high-speed agitator for 20 min at a maintained liquid temperature of 40° C. or less. Biocompatible ink B1 was obtained after filtration through a 2-μm filter.

Biocompatible inks B2 and B3

Biocompatible inks B2 and B3 were produced in the same manner as for the biocompatible ink B1, except that the 2-methacryloyloyloxyethyl phosphorylcholine (MPC) in the biocompatible ink B1 was replaced with the biocompatible ink materials listed in Examples 1-3 to 1-4 in Table 1 below.

### Formation of Biocompatible Member Having Composition Gradient Film

A biocompatible member having a 10 μm-thick composition gradient film was formed on a cobalt-chromium alloy base material (Dan Cobalt, medium hard type; manufactured by Nihon Shika Kinzoku Co., Ltd.) using the inkjet drawing method A below. The adhesion of the composition gradient film to the base material, hydrophilicity, water resistance, and anti-blood clotting and anti-cell adsorption properties were evaluated.

### Inkjet Drawing Method A

The biocompatible ink B1 and the adhesion ink A1 were charged into the ink tanks 1 and 2, respectively, represented in FIG. 3. The biocompatible ink B1 and the adhesion ink A1 were supplied to the inkjet heads 1 and 2, respectively.

First, the adhesion ink A1 was ejected from the inkjet head 2 in a nitrogen gas atmosphere in a controlled droplet amount of 10 pL and a controlled droplet size of 30 μm. Here, the ink layer 1 was formed without ejecting the biocompatible ink B1 from the inkjet head 1 (specifically, the ratio of the amount of the ink ejected from the inkjet head 2 and the amount of the ink ejected from the inkjet head 1 were 100:0 (mass %)). The ink layer 1 was partially cured with active energy rays. Specifically, the ink layer 1 was cured with less energy than that used for complete curing (using a metal halide lamp in a cumulative exposure amount of 1,000 mJ/cm²).

The layers were laminated by repeating the same partial curing as for the ink A1 layer with varying ejection amount ratios (mass %) of the inks ejected from the inkjet heads 2 and 1 in a range of from 75:25 (ink layer 2), 50:50 (ink layer 3), 25:75 (ink layer 4), to 0:100 (ink layer 5). Finally, the layers were completely cured (using a metal halide lamp in a cumulative exposure amount of 5,000 mJ/cm²) to form a biocompatible member having a composition gradient film.

For the formation of the ink layer 2, the biocompatible ink B1 was ejected from the inkjet head 1 in an droplet amount of 5 pL and in a droplet size of 20 μm, and the adhesion ink A1 was ejected from the inkjet head 2 in an ejection amount of 10 pL and in a droplet size of 30 μm. In the formation of the ink layer 3, the biocompatible ink B1 was ejected in an droplet amount of 10 pL and in a droplet size of 30 μm, and the adhesion ink A1 was ejected in a droplet amount of 10 pL and in a droplet size of 30 μm. In the formation of the ink layer 4, the biocompatible ink B1 was ejected in a droplet amount of 10 pL and in a droplet size of 30 μm, and the adhesion ink A1 was ejected in a droplet amount of 5 pL and in a droplet size of 20 μm. For the formation of the ink layer 5, the biocompatible ink B was ejected in a droplet amount of 10 pL and in a droplet size of 30 μm. The ink layers 1 to 5 each had a thickness of 2 μm after the complete curing.

### (Evaluation)

### Adhesion

A cross hatch test (EN ISO2409) was conducted for the biocompatible member prepared. Evaluation was made according to the ISO2409 and the results were represented in scores of 0 to 5, 0 being the highest adhesion, and 5 being the lowest.

### Hydrophilicity

A water droplet contact angle in air on the surface of the composition gradient film of the biocompatible member was measured using a DropMaster 500 (manufactured by Kyowa Interface Science Co., Ltd.).

### Water Resistance

The biocompatible member (having the size of 120 cm²) was rubbed 10 strokes with a sponge (PS sponge; manufactured by FUJIFILM Corporation) in water under an applied load of 1 kg, and the percentage of the remaining film was measured from the mass change of the biocompatible member before and after the rubbing. The percentage remaining film was used as an index of water resistance. Specifically, the percentage remaining film was calculated according to the following equation.

Percentage remaining film (%)={(mass of the biocompatible member after rubbing)/(mass of the biocompatible member before rubbing)}×100

### Anti-Blood Clotting and Anti-Cell Adsorption Properties

The adsorption amount of the protein (fibrinogen) that triggers blood clotting and cell adsorption was evaluated as follows, and used as an index of anti-blood clotting and anti-cell adsorption properties.

A test piece (1 cm²) removed from the biocompatible member was placed in a 5 cm-diameter petri dish. After adding a 1 g/L albumin aqueous solution in an amount of about 10 ml, the dish was stored in a 24 h, 20(C environment. The adsorption amount of albumin was then measured after washing the sample with water. The measured albumin adsorption amount was evaluated according to the following criteria.

A: Less than 0.1 μg/cm²

B: 0.1 μg/cm² or more and less than 0.3 μg/cm²

C: 0.3 μg/cm² or more

The evaluation results for the biocompatible member formed in Example 1-1 are presented in Table 1 below.

### Example 1-2

Ink G1 (A1:B1 mixture ratio (mass %)=75:25), ink G2 (A1:B1 mixture ratio (mass %)=50:50), and ink G3 (A1:B1 mixture ratio (mass %)=25:75) were produced as mixtures of the adhesion ink A1 and the biocompatible ink B1 used in Example 1-1. A total of five inks including A1 and B1 were used to form a biocompatible member having a 10 μm-thick composition gradient film, using five print heads in total. The composition gradient film was formed on a cobalt-chromium alloy base material by forming layers A1 (lowermost layer), G1, G2, G3, and B1 (uppermost layer) in this order using the inkjet drawing method B below. The adhesion of the composition gradient film to the base material, hydrophilicity, water resistance, and anti-blood clotting and anti-cell adsorption properties were evaluated, in the same manner as in Example 1-1. The results are presented in Table 1 below.

### Inkjet Drawing Method B

The inks A1, G1, G2, G3, and B1 were charged into the ink tanks 60-1 to 60-5, respectively, represented in FIG. 7. The inks 1, G1, G2, G3, and B1 were supplied to the inkjet heads 50-1 to 50-5, respectively.

First, the ink A1 was ejected from the inkjet head 50-1 in a nitrogen gas atmosphere in a controlled droplet amount of 10 pL and in a controlled droplet size of 30 μm.

The ink A1 layer was then partially cured with active energy rays. Specifically, the ink layer was cured with less energy than that used for complete curing (using a metal halide lamp in a cumulative exposure amount of 1,000 mJ/cm²).

Then, the ink G1 was ejected from the inkjet head 50-2 to laminate an ink G1 layer, which was then partially cured in the same manner as for the ink A1 layer. The lamination and partial curing were repeated with the inks G2, G3, and B1, and the layers were finally completely cured (using a metal halide lamp in a cumulative exposure amount of 5,000 mJ/cm²) to form a composition gradient film.

The ink layers A1, G1, G2. G3, and B1 each had a thickness of 2 μm after the complete curing.

### Examples 1-3 to 1-12

Biocompatible members having 10 μm-thick composition gradient films were formed by using the same method as used in Example 1-1, except that the biocompatible inks and the adhesion inks were replaced to those listed in Table 1 were used. The adhesion of the composition gradient film to the base material, hydrophilicity, water resistance, and anti-blood clotting and anti-cell adsorption properties were evaluated in the same manner as in Example 1-1. The results are presented in Table 1.

### Comparative Example 1

A single layer of a 10 μm-thick anti-blood clotting and anti-cell adsorption film was formed by inkjet drawing on a cobalt-chromium alloy base material by using only the biocompatible ink B1 used in Example 1-1. The film was evaluated in the same manner as in Example 1-1. The results are presented in Table 1.

### Comparative Example 2

An anti-blood clotting and anti-cell adsorption film having a film thickness of 5 μm, constituted by only one layer, was formed by inkjet drawing by using the biocompatible ink B1 used in Example 1-1 on a film (film thickness: 5 μm) formed by the UV curing after applying the adhesion ink A1 to a cobalt-chromium alloy base material with a bar coater. The film was evaluated in the same manner as in Example 1-1. The results are presented in Table 1.

TABLE 1

| | | | Biocompatible | | | |
|---|---|---|---|---|---|---|
| | | | ink material | | | |
| | | | Anti-clotting | | | |
| | Kinds of Inks | | and anti-cell | | | |
| | Biocompatible | Adhesion | adsorption material | Adhesion ink constituent materials | | |
| | ink | ink | (monomers) | Monomer material (I) | Content (wt %) | |
| Example | | | | | | |
| No. | | | | | | |
| 1-1 | B1 | A1 | MPC | N-Vinyl caprolactam | 50 | |
| | | | | (manufactured by | | |
| | | | | SIGMA-ALDRICH) | | |
| 1-2 | B1 | A1 | MPC | N-Vinyl caprolactam | 50 | |
| | | | | (manufactured by | | |
| | | | | SIGMA-ALDRICH) | | |
| 1-3 | B2 | A1 | 2-Acryloyloxyethyl | N-Vinyl caprolactam | 50 | |
| | | | phosphorylcholine | (manufactured by | | |
| | | | | SIGMA-ALDRICH) | | |
| 1-4 | B3 | A1 | 4-Methacryloyloxybutyl | N-Vinyl caprolactam | 50 | |
| | | | phosphorylcholine | (manufactured by | | |
| | | | | SIGMA-ALDRICH) | | |
| 1-5 | B1 | A2 | MPC | N-Vinyl caprolactam | 50 | |
| | | | | (manufactured by | | |
| | | | | SIGMA-ALDRICH) | | |
| 1-6 | B1 | A3 | MPC | N-Vinyl caprolactam | 50 | |
| | | | | (manufactured by | | |
| | | | | SIGMA-ALDRICH) | | |
| 1-7 | B1 | A4 | MPC | N-Vinyl caprolactam | 30 | |
| | | | | (manufactured by | | |
| | | | | SIGMA-ALDRICH) | | |
| 1-8 | B1 | A5 | MPC | — | — | |
| 1-9 | B1 | A6 | MPC | N-Vinyl caprolactam | 70 | |
| | | | | (manufactured by | | |
| | | | | SIGMA-ALDRICH) | | |
| 1-10 | B1 | A7 | MPC | N-Vinyl pyrrolidone | 50 | |
| | | | | (manufactured by | | |
| | | | | SIGMA-ALDRICH) | | |
| 1-11 | B1 | A8 | MPC | Acryloylmorpholine | 50 | |
| | | | | (manufactured by Kohjin) | | |
| 1-12 | B1 | A9 | MPC | N-Vinyl pyrrolidone | 90 | |
| | | | | (manufactured by | | |
| | | | | SIGMA-ALDRICH) | | |
| Compara- | | | | | | |
| tive, | | | | | | |
| Example | | | | | | |
| No. | | | | | | |
| 1 | B1 | — | MPC | — | — | |
| 2 | B1 | A1 | MPC | N-Vinyl caprolactam | 50 | |
| | | | | (manufactured by | | |
| | | | | SIGMA-ALDRICH) | | |
| | | | | | | Anti-clotting |
| | Adhesion ink constituent materials | | | | | and anti-cell |
| | Monomer | Content | | | Water | adsorption |
| | material (II) | (wt %) | Adhesion | Hydrophilicity | resistance | properties |
| Example. No | | | | | | |
| 1-1 | Diethylene glycol diacrylate | 40 | 0 | 10° | l00% | A |
| | (manufactured by Akcros) | | | | | |
| 1-2 | Diethylene glycol diacrylate | 40 | 0 | 12° | l00% | A |
| | (manufactured by Akcros) | | | | | |
| 1-3 | Diethylene glycol diacrylate | 40 | 0 | 8° | l00% | A |
| | (manufactured by Akcros) | | | | | |
| 1-4 | Diethylene glycol diacrylate | 40 | 0 | 15° | 100% | A |
| | (manufactured by Akcros) | | | | | |
| 1-5 | Divinyl benzene | 40 | 0 | 11° | l00% | A |
| | (manufactured by Tokyo | | | | | |
| | Chemical Industry Co., Ltd.) | | | | | |
| 1-6 | Phenoxyethyl acrylate | 40 | 0 | 10° | 90% | A |
| | (manufactured by Tokyo | | | | | |
| | Chemical Industry Co., Ltd.) | | | | | |
| 1-7 | Phenoxyethyl acrylate | 60 | 0 | 12° | 92% | A |
| | (manufactured by Tokyo | | | | | |
| | Chemical Industry Co., Ltd.) | | | | | |
| 1-8 | Phenoxyethyl acrylate | 90 | 2 | 9° | 95% | A |
| | (manufactured by Tokyo | | | | | |
| | Chemical Industry Co., Ltd.) | | | | | |
| 1-9 | Dipropylene glycol diacrylate | 20 | 0 | 8° | 100% | A |
| | (manufactured by Akcros) | | | | | |
| 1-10 | Dipropylene glycol diacrylate | 40 | 1 | 13° | 100% | A |
| | (manufactured by Akcros) | | | | | |
| 1-11 | Dipropylene glycol diacrylate | 40 | 1 | 12° | 100% | A |
| | (manufactured by Akcros) | | | | | |
| 1-12 | — | — | 1 | 10° | 100% | A |
| Comparative | | | | | | |
| Example No. | | | | | | |
| 1 | — | — | 5 | 11° | 5% | C |
| 2 | Dipropylene glycol diacrylate | 40 | 5 | 10° | 35% | B |
| | (manufactured by Akcros) | | | | | |

The compositions of the composition gradient films of the biocompatible members of Examples 1-1 to 1-12 were measured by XPS analysis. Specifically, the proportion of the mass of 1) the compound having a phosphorylcholine group with respect to the total mass of 1) the compound having a phosphorylcholine group and 2) the polymer of a polymerizable compound was measured for each 0.1-μm thickness of the film along the film thickness direction from the side closest to the base material. The difference of the proportion at the all adjacent measurement points was 1% to 50%.

It was found that the biocompatible members of Examples 1-1 to 1-12 had desirable adhesion between the base material and the composition gradient film, and desirable hydrophilicity, water resistance, and anti-blood clotting and anti-cell adsorption properties. The biocompatible members having the composition gradient films produced by using the inkjet methods A (mixed drawing method) and B (mixed ink method) were also found to be practically effective in terms of anti-blood clotting and anti-cell adsorption functions. Specifically, it was possible to form a sufficiently functional anti-blood clotting and anti-cell adsorption surface, regardless of which of the two inkjet methods was used. As for adhesion, more desirable performance was obtained in Examples in which the adhesion inks containing N-vinyl lactams were used, compared to Examples in which the adhesion inks containing no N-vinyl lactams were used. This is believed to be due to the formation of a strong film having a high cohesive force in the composition gradient film, in addition to having the desirable adhesion provided by the coordinate interaction between the N-vinyl lactams and the metallic base. Further, the anti-blood clotting and anti-cell adsorption surface having a phosphorylcholine group maintained high water resistance with the interpenetrating network (IPN) structure formed with the adhesion ink material portions by crosslinking structure.

On the other hand, the film formed by common inkjet drawing using only the biocompatible ink of the present invention as in Comparative Example 1 is hydrophilic, and easily detaches because of the lack of the adhesion to the base material. Sufficient adhesion to the base material was obtained in Comparative Example 2 because of the lamination of the biocompatible ink and the adhesion ink. However, because of the dissimilar interface, a cohesive failure occurred in the layer, and the film had only weak adhesion strength. It was therefore not possible to obtain high water resistance and desirable anti-blood clotting and anti-cell adsorption properties at the same time.

### Example 2-1

### Production of Ink Composition Containing Oligomer or Polymer Compound

### Oligomer/Polymer Adhesion Ink; Hereinafter, “Adhesion Ink”

| | |
|---|---|
| Urethane oligomer UN-1225 (manufactured by Negami Chemical | 50 g |
| Industrial Co., Ltd.) | |
| Cyclohexanon (manufactured by Wako Pure Chemical Industries, | 450 g |
| Ltd.) | |

The materials were charged into a 2-L container, and agitated with a Silverson high-speed agitator for 20 min at a maintained liquid temperature of 40° C. or less. Adhesion ink C1 was obtained after filtration through a 2-μm filter.

### Adhesion Inks C2 to C7

Adhesion inks C2 to C7 were induced in the same manner as for the adhesion ink C1, except that the urethane oligomer UN-1225 (manufactured by Negami Chemical Industrial Co., Ltd.) used for the adhesion ink C1 was replaced with the adhesion ink constituent materials listed in Examples 2-5 to 2-10 in Table 2 below.

### Production of Ink Composition Containing Compound Having Phosphorylcholine Group (Hereinafter, “Biocompatible Ink”)

### Biocompatible Ink D

<Production of anti-clogging and anti-cell adsorption
(biocompatible) polymer a>

| | |
|---|---|
| 2-Methacryloyloxyethyl phosphorylcholine (MPC) | 94 g |
| Diethylene glycol dimethacrylate (manufactured by | 2 g |
| Tokyo Chemical Industry Co., Ltd.) | |
| VA061 (manufactured by Wako Pure Chemical Industries) | 4 g |
| Methoxyethanol (manufactured by Wako Pure Chemical | 150 g |
| Industries) | |
| Ion-exchange water | 50 g |

All the materials except for VA061 were charged into a 1-L four-neck flask, heated to 75° C. under a stream of nitrogen, and agitated for 30 min.

After adding the radical polymerization initiator VA061 (2 g), a polymerization reaction was performed at 75° C. for 4 hours under a stream of nitrogen. The radical polymerization initiator VA061 (1 g) was added further, and a polymerization reaction was performed at 75° C. for 2 hours. After further adding the radical polymerization initiator VA061 (1 g), the temperature was raised to 85° C. and a polymerization reaction was performed at 85° C. for 2 hours. The mixture was then cooled to room temperature. Methanol (3 L) was charged into a 5-L stainless-steel container, and the polymer solution was dropped while stirring the mixture to reprecipitate and purify the solution. A polymer (about 90 g) was obtained upon vacuum drying.

| | |
|---|---|
| Anti-blood clotting and anti-cell adsorption (biocompatible) | 50 g |
| polymer a | |
| Cyclohexanon (manufactured by Wako Pure Chemical Industries) | 450 g |

The materials were charged into a 2-L container, and agitated with a Silverson high-speed agitator for 20 min at a maintained liquid temperature of 40° C. or less. Biocompatible ink D1 was obtained after filtration through a 2-μm filter.

### Biocompatible Inks D2 and D3

Biocompatible inks D2 and D3 were produced in the same manner as for the biocompatible ink D1, except that the anti-blood clotting and anti-cell adsorption (biocompatible) polymers of Examples 2-3 and 2-4 in Table 2 below were used instead of the anti-blood clotting and anti-cell adsorption (biocompatible) polymer a used for the biocompatible ink D1.

The anti-blood clotting and anti-cell adsorption (biocompatible) polymers of Examples 2-3 and 2-4 in Table 2 were produced in the same manner as for the anti-blood clotting and anti-cell adsorption (biocompatible) polymer a, except that 2-acryloyloxyethyl phosphorylcholine and 4-methacryloyloxybutyl phosphorylcholine were used instead of the 2-methacryloyloxyethyl phosphorylcholine (MPC).

### (Formation of Biocompatible Member Having Composition Gradient Film)

A biocompatible member having a 10 μm-thick composition gradient film was formed on a cobalt-chromium alloy base material (Dan Cobalt, medium hard; manufactured by Nihon Shika Kinzoku Co., Ltd.) using the inkjet drawing method C below. The adhesion of the composition gradient film to the base material, hydrophilicity, water resistance, and anti-blood clotting and anti-cell adsorption properties were evaluated in the same manner as in Example 1-1.

### Inkjet Drawing Method C

The biocompatible ink D1 and the adhesion ink C1 were charged into the ink tank 1 and the ink tank 2, respectively, represented in FIG. 3. The biocompatible ink D1 and the adhesion ink C1 were supplied to the inkjet head 1 and the inkjet head 2, respectively.

First, the adhesion ink C1 was ejected from the inkjet head 2 in a nitrogen gas atmosphere in a controlled droplet amount of 10 pL and in a controlled droplet size of 30 μm. Here, the ink layer 1 was formed without ejecting the biocompatible ink D1 from the inkjet head 1 (specifically, proportion of the amount of the ink ejected from the inkjet head 2 and the amount of the ink ejected from the inkjet head 1 were 100:0 (mass %)). The layer was semi-dried at 80° C. for 30 sec.

The layers were laminated by repeating the same semi-drying as for the ink layer 1 with varying ejection amount ratios (mass %) of the inks ejected from the inkjet heads 2 and 1 in a range of from 75:25 (ink layer 2), 50:50 (ink layer 3), 25:75 (ink layer 4), to 0:100 (ink layer 5). Finally, the layers were completely dried (110° C. for 60 seconds) to form a biocompatible member having a composition gradient film.

For the formation of the ink layer 2, the biocompatible ink D1 was ejected from the inkjet head 1 in a droplet amount of 5 pL and in a droplet size of 20 μm, and the adhesion ink C1 was ejected from the inkjet head 2 in an ejection amount of 10 pL and in a droplet size of 30 μm. For the formation of the ink layer 3, the biocompatible ink D1 was ejected in a droplet amount of 10 pL and in a droplet size of 30 μm, and the adhesion ink C1 was ejected in an ejection amount of 10 pL and in a droplet size of 30 μm. For the formation of the ink layer 4, the biocompatible ink D1 was ejected in a droplet amount of 10 pL and in a droplet size of 30 μm, and the adhesion ink C1 was ejected in an ejection amount of 5 pL and in a droplet size of 20 μm. For the formation of the ink layer 5, the biocompatible ink D1 was ejected in a droplet amount of 10 pL and in a droplet size of 30 μm. The ink layers 1 to 5 each had a thickness of 2 μm after the complete drying.

The results of the evaluation for the biocompatible member formed in Example 2-1 are presented in Table 2.

### Example 2-2

Ink H1 (C1:D1 mixture ratio (mass %)=75:25), ink H2 (C1:D1 mixture ratio (mass %)=50:50), and ink H3 (C1:D1 mixture ratio (mass %)=25:75) were produced as mixtures of the adhesion ink C1 and the biocompatible ink D1 used in Example 2-1. A total of five inks including C1 and D1 were used to form a biocompatible member having a 10 μm-thick composition gradient film, using five print heads. The composition gradient film was formed on a cobalt-chromium alloy base material by forming layers C1 (lowermost layer), H1, H2, H3, and D1 (uppermost layer) in this order using the inkjet drawing method D below.

The adhesion of the composition gradient film to the base material, hydrophilicity, water resistance, and anti-blood clotting and anti-cell adsorption properties were evaluated in the same manner as in Example 1-1. The results are presented in Table 2.

### Inkjet Drawing Method D

The inks C1, H1, H2, H3, and D1 were charged into the ink tanks 60-1 to 60-5, respectively, represented in FIG. 7. The inks C1, H1, H2, H3, and D1 were supplied to the inkjet heads 50-1 to 50-5, respectively.

First, the ink C1 was ejected from the inkjet head 50-1 in a nitrogen gas atmosphere in a controlled droplet amount of 10 pL and in a controlled droplet size of 30 μm.

The ink C1 layer was semi-dried at 80° C. for 30 sec.

Then, the ink H1 was ejected from the inkjet head 50-2 to laminate an ink H1 layer, and the ink H1 layer was semi-dried in the same manner as for the ink C1 layer. The lamination and semi-drying were repeated with the inks H2, H3, and D1, and, finally, the layers were completely dried (110° C. for 60 sec.) to produce a composition gradient film.

The ink layers C1, H1, H2. H3, and D1 each had a thickness of 2 μm after the complete drying.

### Examples 2-3 to 2-10

Biocompatible members having a 10 μm-thick composition gradient film were formed by using the same method used in Example 2-1, except that the biocompatible ink and the adhesion ink listed in Table 2 were used.

The adhesion of the composition gradient film to the base material, hydrophilicity, water resistance, and anti-blood clotting and anti-cell adsorption properties were evaluated in the same manner as in Example 2-1. The results are presented in Table 2.

### Comparative Example 3

A single layer of a 10 μm-thick anti-blood clotting and anti-cell adsorption film was formed by inkjet drawing on a cobalt-chromium alloy base material by using only the biocompatible ink D1 used in Example 2-1. The film was evaluated in the same manner as in Example 2-1. The results are presented in Table 2.

### Comparative Example 4

An anti-blood clotting and anti-cell adsorption film having a film thickness of 2 μm, constituted by only one layer, was formed by inkjet drawing by using the biocompatible ink D1 used in Example 2-1 on a film (film thickness 2 μm) formed by drying after applying the adhesion ink C1 to a cobalt-chromium alloy base material with a bar coater. The film was evaluated in the same manner as in Example 2-1. The results are presented in Table 2.

TABLE 2

| | | | Ink constituent materials | |
|---|---|---|---|---|
| | Kinds of Inks | | (Biocompatible ink material) | |
| | Biocompatible | Adhesion | Anti clotting and anti-cell | (Adhesion ink constituent material) |
| | ink | ink | adsorption polymer | Oligomer/polymer adhesion ink |
| Example | | | | |
| No. | | | | |
| 2-1 | D1 | C1 | MPC polymer | Urethane oligomer UN-1225 |
| | | | | (manufactured by Negami |
| | | | | Chemical Industrial Co., Ltd.) |
| 2-2 | D1 | C1 | MPC polymer | Urethane oligomer UN-1225 |
| | | | | (manufactured by Negami |
| | | | | Chemical Industrial Co., Ltd.) |
| 2-3 | D2 | C1 | 2-Acryloyloxyethyl | Urethane oligomer UN-1225 |
| | | | phosphorylcholine | (manufactured by Negami |
| | | | polymer | Chemical Industrial Co., Ltd.) |
| 2-4 | D3 | C1 | 4-Methacryloyloxybutyl | Urethane oligomer UN-1225 |
| | | | phosphorylcholine | (manufactured by Negami |
| | | | polymer | Chemical Industrial Co., Ltd.) |
| 2-5 | D1 | C2 | MPC polymer | Urethane oligomer CN962 |
| | | | | (manufactured by Sartomer) |
| 2-6 | D1 | C3 | MPC polymer | Urethane oligomer CN965 |
| | | | | (manufactured by Sartomer) |
| 2-7 | D1 | C4 | MPC polymer | Urethane oligomer CN971 |
| | | | | (manufactured by Sartomer) |
| 2-8 | D1 | C5 | MPC polymer | Polybutyl methacrylate |
| | | | | (manufactured by SIGMA-ALDRICH) |
| 2-9 | D1 | C6 | MPC polymer | Urethane oligomer CN965 (manufactured |
| | | | | by Sartomer)/polybutyl |
| | | | | methacrylate (manufactured by |
| | | | | SIGMA-ALDRICH) = 20/80 (mass %) |
| 2-10 | D1 | C7 | MPC polymer | Urethane oligomer CN965 (manufactured |
| | | | | by Sartomer)/polybutyl |
| | | | | methacrylate (manufactured by |
| | | | | SIGMA-ALDRICH) = 40/60 (mass %) |
| Comparative | | | | |
| Example | | | | |
| No. | | | | |
| 3 | D1 | — | MPC polymer | — |
| 4 | D1 | C1 | MPC polymer | Urethane oligomer UN-1225 |
| | | | | (manufactured by Negami |
| | | | | Chemical Industrial Co., Ltd.) |
| | | | Water | Anti-clotting and anti-cell |
| | Adhesion | Hydrophilicity | resistance | adsorption properties |
| Example No. | | | | |
| 2-1 | 0 | 12° | 100% | A |
| 2-2 | 0 | 10° | 100% | A |
| 2-3 | 0 | 8° | 100% | A |
| 2-4 | 0 | 15° | 100% | A |
| 2-5 | 0 | 11° | 100% | A |
| 2-6 | 0 | 13° | 100% | A |
| 2-7 | 0 | 10° | 100% | A |
| 2-8 | 2 | 12° | 100% | |
| 2-9 | 1 | 14° | 100% | A |
| 2-10 | 0 | 10° | 100% | A |
| Comparative | | | | |
| Example. No. | | | | |
| 3 | 5 | 14° | 3% | C |
| 4 | 5 | 10° | 32% | B |

The compositions of the composition gradient films of the biocompatible members of Examples 2-1 to 2-10 were measured by XPS analysis. Specifically, the proportion of the mass of 1) the compound having a phosphorylcholine group with respect to the total mass of 1) the compound having a phosphorylcholine group and 2) the oligomer or polymer compound was measured for each 0.1-μm thickness of the film along the film thickness direction from the side closest to the base material. The different of the proportion at the all adjacent measurement points was 1% to 50%.

It was found that the biocompatible members of Examples 2-1 to 2-10 had desirable adhesion between the base material and the composition gradient film, and desirable hydrophilicity, water resistance, and anti-blood clotting and anti-cell adsorption properties. The biocompatible members having the composition gradient films produced by using the inkjet methods C (mixed drawing method) and D (mixed ink method) were also found to be practically effective in terms of anti-blood clotting and anti-cell adsorption functions. Specifically, it was possible to form a sufficiently functional anti-blood clotting and anti-cell adsorption surface, regardless of which of the two inkjet methods was used. As for adhesion, more desirable performance was obtained in Examples in which the adhesion inks containing urethane oligomers were used, compared to Examples in which the adhesion inks containing no urethane oligomers were used. This is believed to be due to the formation of a strong film having a high cohesive force in the composition gradient film, in addition to having the desirable adhesion provided by interactions such as the hydrogen bonding and the coordinate interaction between the urethane oligonmers and the metallic base. Further, the anti-blood clotting and anti-cell adsorption surface having a phosphorylcholine group maintained high water resistance with the interpenetrating network (IPN) structure formed with the adhesion ink material portions by crosslinking structure.

On the other hand, the film formed by common inkjet drawing using only the biocompatible ink of the present invention as in Comparative Example 3 is hydrophilic, and easily detaches because of the lack of the adhesion to the base material. Sufficient adhesion to the base material was obtained in Comparative Example 4 because of the lamination of the biocompatible ink and the adhesion ink. However, because of the dissimilar interface, a cohesive failure occurred in the layer, and the film had only weak adhesion strength. It was therefore not possible to obtain high water resistance and desirable anti-blood clotting and anti-cell adsorption properties at the same time.

### INDUSTRIAL APPLICABILITY

According to present invention, a biocompatible member and a method for forming same that provide desirable adhesion between various base materials of the biocompatible member and a film, and that impart high biocompatibility to the film surface while maintaining excellent hydrophilicity and water resistance can be provided.

This application is based on Japanese patent application filed on Sep. 27, 2011 (Japanese Patent Application No. 2011-211329), and the contents thereof are incorporated herein by reference.

### REFERENCE SIGNS LIST

1 Biocompatible member
2 Base material
3 Composition gradient film
10 Drawing unit
100 Composition gradient film producing apparatus

1. A biocompatible member comprising:
a base material; and
a film provided on the base material,
wherein the biocompatible member includes:
1) a compound having a phosphorylcholine group, and
2) a polymer of a polymerizable compound, or an oligomer or polymer compound, provided that 2) the polymer of a polymerizable compound, or the oligomer or polymer compound does not have a phosphorylcholine group,
the film is a composition gradient film in which the composition of 1) and 2) continuously varies in such a manner that the proportion of 1) increases and the proportion of 2) decreases from the side closest to the base material to the side farthest from the base material along a film thickness direction.

2. The biocompatible member according to claim 1,
wherein the composition gradient film has a thickness of 1 μm or more, and
wherein the proportion of the mass of 1) the compound having a phosphorylcholine group with respect to the total mass of 1) the compound having a phosphorylcholine group, and 2) the polymer of a polymerizable compound, or the oligomer or polymer compound in the composition gradient film has a 1% to 50% difference between any adjacent measurement points taken at 0.1-μm intervals from the side closest to the base material along the film thickness direction.

3. The biocompatible member according to claim 1,
wherein the polymerizable compound, or the oligomer or polymer compound has two or more polymerizable functional groups per molecule.

4. The biocompatible member according to claim 1,
wherein 1) the compound having a phosphorylcholine group is 2-methacryloyloxyethyl phosphorylcholine, or a polymer thereof.

5. The biocompatible member according to claim 1,
wherein the component 2) is a polymer of a polymerizable compound, and the polymerizable compound contains at least one selected from the group consisting of an N-vinyl compounds and a (meth)acrylate compound.

6. The biocompatible member according to claim 5, wherein the polymerizable compound contains N-vinyl caprolactam as the N-vinyl compound.

7. The biocompatible member according to claim 6, wherein the content of the N-vinyl caprolactam in the polymerizable compound is 40 mass % or more.

8. The biocompatible member according to claim 1,
wherein the component 2) is a polymer of a polymerizable compound, and is formed by polymerizing and curing the polymerizable compound with an active energy ray.

9. The biocompatible member according to claim 1,
wherein the component 2) is an oligomer or polymer compound, and the oligomer or polymer compound contains a urethane bond.

10. A method for forming the biocompatible member of claim 1, comprising:
ejecting on the base material at least two ink compositions including an ink composition containing the compound having a phosphorylcholine group, and an ink composition containing the polymerizable compound or the oligomer or polymer compound by using an inkjet method.

11. The method according to claim 10,
wherein the inkjet method uses at least a first inkjet head and a second inkjet head, and the method comprises:
a step of supplying the ink composition containing the compound having a phosphorylcholine group to the first inkjet head as a first ink;
a step of supplying the ink composition containing the polymerizable compound or the oligomer or polymer compound to the second inkjet head as a second ink;
a control step of deciding the proportion of the amount of the first ink ejected from the first inkjet head and the proportion of the amount of the second ink ejected from the second inkjet head;
a forming step of forming a single layer by ejecting the first ink or the second ink from at least one of the first inkjet head and the second inkjet head according to the decided proportions; and
a laminate step of repeating the forming step to laminate a plurality of layers on the base material and obtain the composition gradient film,
wherein in the control step the proportions are decided in such a manner that the proportion of the first ink increases and the proportion of the second ink decreases from the side closest to the base material to the side farthest from the base material along the thickness of the plurality of layers.

12. The method according to claim 11,
wherein the amount of ink droplets ejected from the first inkjet head and the second inkjet head in the forming step is 0.3 to 100 pL.

13. The method according to claim 11, wherein the size of ink droplets ejected from the first inkjet head and the second inkjet head in the forming step is 1 to 300 μm.

14. The method according to claim 10,
wherein the inkjet method uses a plurality of inkjet heads, and the method comprises:
a step of supplying mixed inks to the respective inkjet heads of the plurality of inkjet heads in which the mixed inks are the mixed inks of the first ink which is an ink composition containing the compound having a phosphorylcholine group and the second ink which is an ink composition containing the polymerizable compound or the oligomer or polymer compound, and the mixed inks are different from one another in mixed proportion of the first ink and the second ink;
a selecting step of sequentially selecting an inkjet head from the plurality of inkjet heads in order of decreasing proportions of the second ink in the mixed inks;
a forming step of forming a single layer by ejecting the mixed ink from the selected inkjet head; and
a laminate step of repeating the forming step to laminate a plurality of layers on the base material and obtain the composition gradient film.

15. The method according to claim 14,
wherein the amount of ink droplets ejected from the selected inkjet head in the forming step is 0.5 to 150 pL.

16. The method according to claim 14,
wherein the size of ink droplets ejected from the selected inkjet head in the forming step is 2 to 450 μm.

17. The biocompatible member according to claim 1,
wherein the biocompatible member is formed by ejecting on the base material at least two ink compositions including an ink composition containing the compound having a phosphorylcholine group, and an ink composition containing the polymerizable compound or the oligomer or polymer compound by using an inkjet method,
wherein the inkjet method uses at least a first inkjet head and a second inkjet head, and the method includes:
a step of supplying the ink composition containing the compound having a phosphorylcholine group to the first inkjet head as a first ink;
a step of supplying the ink composition containing the polymerizable compound or the oligomer or polymer compound to the second inkjet head as a second ink;
a control step of deciding the proportion of the amount of the first ink ejected from the first inkjet head and the proportion of the amount of the second ink ejected from the second inkjet head;
a forming step of forming a single layer by ejecting the first ink or the second ink from at least one of the first inkjet head and the second inkjet head according to the decided proportions; and
a laminate step of repeating the forming step to laminate a plurality of layers on the base material and obtain the composition gradient film,
wherein in the control step the proportions are decided in such a manner that the proportion of the first ink increases and the proportion of the second ink decreases from the side closest to the base material to the side farthest from the base material along the thickness of the plurality of layers.

18. The biocompatible member according to claim 1,
wherein the biocompatible member is formed by ejecting on the base material at least two ink compositions including an ink composition containing the compound having a phosphorylcholine group, and an ink composition containing the polymerizable compound or the oligomer or polymer compound by using an inkjet method,
wherein the inkjet method uses a plurality of inkjet heads, and the method includes:
a step of supplying mixed inks to the respective inkjet heads of the plurality of inkjet heads in which the mixed inks are the mixed inks of the first ink which is an ink composition containing the compound having a phosphorylcholine group and the second ink which is an ink composition containing the polymerizable compound or the oligomer or polymer compound, and the mixed inks are different from one another in mixed proportion of the first ink and the second ink;
a selecting step of sequentially selecting an inkjet head from the plurality of inkjet heads in order of decreasing proportions of the second ink in the mixed inks;
a forming step of forming a single layer by ejecting the mixed ink from the selected inkjet head; and
a laminate step of repeating the forming step to laminate a plurality of layers on the base material and obtain the composition gradient film.
